(19) United States
(12) Patent Application Publication
(10) Pub. No.: US 2015/0318968 A1
(43) Pub. Date: Nov. 5, 2015

(54) METHOD FOR TRANSMITTING SYSTEM INFORMATION IN WIRELESS ACCESS SYSTEM SUPPORTING ULTRAHIGH FREQUENCY AND DEVICE FOR SUPPORTING SAME

(71) Applicant: LG ELECTRONICS INC., Yeongdeungpo-gu, Seoul (KR)

(72) Inventors: Kitae KIM, Anyang-si, Gyeonggi-do (KR); Jinmin KIM, Anyang-si, Gyeonggi-do (KR); Hyunsoo KO, Anyang-si, Gyeonggi-do (KR); Jaehoon CHUNG, Anyang-si, Gyeonggi-do (KR)

(73) Assignee: LG ELECTRONICS INC., Seoul (KR)

(21) Appl. No.: 14/650,198

(22) PCT Filed: Dec. 10, 2013
(86) PCT No.: PCT/KR2013/011397

§ 371 Date: Jun. 5, 2015

Related U.S. Application Data
(60) Provisional application No. 61/735,067, filed on Dec. 10, 2012.

(51) Int. Cl. H04L 5/00; H04L 12/825; H04L 29/06

(52) U.S. Cl. CPC H04L 5/0048; H04L 65/4076; H04L 47/26

(57) ABSTRACT

The present invention relates to a wireless access system supporting an ultrahigh frequency band, and more particularly, to a method for constructing a reference signal for system information transmission in an ultrahigh frequency band, and a device for supporting the same. According to one embodiment of the present invention, a method for transmitting system information in a wireless access system supporting an ultrahigh frequency band can comprise the steps of: allocating to a specific subframe, by a base station, at least one among a broadcast channel region and a unicast channel region for transmitting system information; and transmitting, by the base station, the system information by using at least one among the broadcast channel region and the unicast channel region. In this situation, a number of first reference signals allocated to the broadcast channel region can be greater than a number of second reference signals allocated to the unicast channel region.

### TECHNICAL FIELD

The present invention relates to a wireless access system for supporting an ultrahigh frequency band, and more particularly, to a method for configuring a reference signal for system information transmission in an ultrahigh frequency band, and an apparatus for supporting the same.

### BACKGROUND ART

Wireless access systems have been widely deployed to provide various types of communication services such as voice or data. In general, a wireless access system is a multiple access system that supports communication of multiple users by sharing available system resources (a bandwidth, transmission power, etc.) among them. For example, multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, and a Single Carrier Frequency Division Multiple Access (SC-FDMA) system.

### DISCLOSURE

### Technical Problem

An object of the present invention devised to solve the problem lies in a method for effectively transmitting data in an ultrahigh frequency band.

Another object of the present invention devised to solve the problem lies in a method for transmitting system information in a system for supporting an ultrahigh frequency band.

Another object of the present invention devised to solve the problem lies in a method for configuring a reference signal for transmitting system information in a system for supporting an ultrahigh frequency band.

It will be appreciated by persons skilled in the art that the objects that could be achieved with the present disclosure are not limited to what has been particularly described hereinabove and the above and other objects that the present disclosure could achieve will be more clearly understood from the following detailed description.

### Technical Solution

The object of the present invention can be achieved by providing a wireless access system for supporting an ultrahigh frequency band, and more particularly, to a method for configuring a reference signal for transmission of system information in an ultrahigh frequency band and an apparatus for supporting the method.

In another aspect of the present invention, provided herein is a method for transmitting system information in a wireless access system for supporting an ultrahigh frequency band, the method including allocating one or more of a broadcast channel region and a unicast channel region, for transmission the system information, to a specific subframe by a base station (BS), and transmitting the system information using one or more of the broadcast channel region and the unicast channel region by the BS, wherein the number of first reference signals allocated to the broadcast channel region is greater than the number of second reference signals allocated to the unicast channel region.

The system information may be transmitted to a specific user equipment (UE) using a narrow beamforming method when the system information is transmitted through the unicast channel region.

The system information may be transmitted to all user equipments (UEs) contained in a cell of the BS when the system information is transmitted through the broadcast channel region.

The method may further include receiving feedback information including channel state information (CSI) from one or more user equipments (UEs), determining a reception mode indicating a channel region for transmitting the system information based on the feedback information, and transmitting information about the reception mode and information about the specific subframe.

The method may further include receiving information about a reception mode indicating a channel region for transmitting the system information, determined based on channel state information (CSI), from one or more user equipments (UEs), and transmitting the system information in the specific frame using information about the reception mode.

In another aspect of the present invention, provided herein is a method for receiving system information in a wireless access system for supporting an ultrahigh frequency band, the method including receiving the system information using one or more of a broadcast channel region and a unicast channel region in a specific subframe, by a user equipment (UE), wherein the number of first reference signals allocated to the broadcast channel region is greater than the number of second reference signals allocated to the unicast channel region.

The system information may be transmitted to the UE using a narrow beamforming method when the system information is transmitted through the unicast channel region.

The system information may be transmitted to all UEs contained in a cell of a base station (BS) when the system information is transmitted through the broadcast channel region.

The method may further include measuring channel state information (CSI) by the UE, transmitting feedback information including the CSI by the UE, and receiving information about the specific subframe and information about a reception mode indicating a channel region for transmitting the system information, determined based on the feedback information.

The method may further include measuring channel state information (CSI) by the UE, determining a reception mode indicating a channel region for transmitting the system information based on the CSI by the UE, transmitting the CSI and information about the reception mode by the UE, and receiving the system information in the specific subframe using the information about the reception mode.

In another aspect of the present invention, provided herein is a base station (BS) for transmitting system information in a wireless access system for supporting an ultrahigh frequency band, the BS including a transmitter, a receiver, and a processor.

In this case, the processor may be configured to allocate one or more of a broadcast channel region and a unicast channel region, for transmission the system information, to a specific subframe, and to transmit the system information using one or more of the broadcast channel region and the unicast channel region through the transmitter, and the number of first reference signals allocated to the broadcast channel region may be greater than the number of second reference signals allocated to the unicast channel region.

The system information may be transmitted to a specific user equipment (UE) using a narrow beamforming method when the system information is transmitted through the unicast channel region.

The system information may be transmitted to all user equipments (UEs) contained in a cell of the BS when the system information is transmitted through the broadcast channel region.

The processor may be configured to control the receiver to receive feedback information including channel state information (CSI) from one or more user equipments (UEs), to determine a reception mode indicating a channel region for transmitting the system information based on the feedback information, and to control the transmitter to transmit information about the reception mode and information about the specific subframe.

The processor may be configured to control the receiver to receive information about a reception mode indicating a channel region for transmitting the system information, determined based on channel state information (CSI) from one or more user equipments (UEs), and to control the transmitter to transmit the system information in the specific subframe using information about the reception mode.

The afore-described aspects of the present disclosure are merely a part of embodiments of the present disclosure. Those skilled in the art will derive and understand various embodiments reflecting the technical features of the present disclosure from the following detailed description of the present disclosure.

### Advantageous Effects

According to the embodiments of the present disclosure, the following effects can be achieved.

First, the present invention may transmit and receive system information using a beamforming method obtained by considering channel characteristics of an ultrahigh frequency band in consideration of coherent time corresponding to the channel characteristics.

Second, a system for supporting an ultrahigh frequency band may adaptively transmit and receive system information according to a channel situation.

Third, system information may be transmitted and received using a new reference signal configuration used in an ultrahigh frequency band.

Fourth, an narrow beamforming effect may be applied to a UE, and density of a reference signal may be reduced, thereby increasing overall system efficiency.

It will be appreciated by persons skilled in the art that that the effects that can be achieved through the present disclosure are not limited to what has been particularly described hereinabove and other advantages of the present disclosure will be more clearly understood from the following detailed description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates physical channels and a general signal transmission method using the physical channels, which may be used in embodiments of the present disclosure;

FIG. 2 illustrates radio frame structures used in embodiments of the present disclosure;

FIG. 3 illustrates a structure of a DownLink (DL) resource grid for the duration of one DL slot, which may be used in embodiments of the present disclosure;

FIG. 4 illustrates a structure of an UpLink (UL) subframe, which may be used in embodiments of the present disclosure;

FIG. 5 illustrates a structure of a DL subframe, which may be used in embodiments of the present disclosure;

FIG. 6 is a diagram illustrating a configuration of a symbol that can be used in embodiments of the present invention;

FIG. 7 is a diagram illustrating an example of a subframe to which a cell specific reference signal (CRS) is allocated, which can be used in embodiments of the present invention;

FIG. 8 is a diagram illustrating an example of subframes in which CSI-RSs that can be used in embodiments of the present invention are allocated according to the number of antenna ports;

FIG. 9 is a diagram illustrating an example of UE-specific reference signals (UE-RSs) that can be used in embodiments of the present invention;

FIG. 10 is a diagram illustrating an example of a DSA that can be configured in embodiments of the present invention;

FIG. 11 is a diagram illustrating a concept of a BTS hotel of a DSA that can be used in embodiments of the present invention;

FIG. 12 is a diagram illustrating a frequency band of a small cell that can be used in embodiments of the present invention;

FIG. 13 is a diagram illustrating distribution of Doppler spectrum during narrow beamforming that can be used in an embodiment of the present invention;

FIG. 14 is a diagram illustrating a case in which a Doppler spectrum is reduced during narrow beamforming according to an embodiment of the present invention;

FIG. 15 is a diagram illustrating an example of a system information transmission channel configuration according to an embodiment of the present invention;

FIG. 16 is a diagram illustrating an example of a reference signal configured used in an ultrahigh frequency band according to an embodiment of the present invention;

FIG. 17 is a diagram illustrating an example of a method for transmitting system information in an ultrahigh frequency band according to an embodiment of the present invention;

FIG. 18 is a diagram illustrating another example of a method for transmitting system information in an ultrahigh frequency band according to an embodiment of the present invention; and

FIG. 19 is a diagram illustrating an apparatus that implements the methods described with reference to FIGS. 1 to 18.

### BEST MODE

The present invention relates to a wireless access system for supporting an ultrahigh frequency band, and more particularly, to a method for configuring a reference signal for transmission of system information in an ultrahigh frequency band and an apparatus for supporting the same.

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the attached drawings, a detailed description of known procedures or steps of the present disclosure will be avoided lest it should obscure the subject matter of the present disclosure. In addition, procedures or steps that could be understood to those skilled in the art will not be described either.

In the embodiments of the present disclosure, a description is mainly made of a data transmission and reception relationship between a Base Station (BS) and a User Equipment (UE). A BS refers to a terminal node of a network, which directly communicates with a UE. A specific operation described as being performed by the BS may be performed by an upper node of the BS.

Namely, it is apparent that, in a network comprised of a plurality of network nodes including a BS, various operations performed for communication with a UE may be performed by the BS, or network nodes other than the BS. The term ‘BS’ may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a UE may serve as a transmitter and a BS may serve as a receiver, on an UpLink (UL). Likewise, the UE may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, and a 3GPP2 system. In particular, the embodiments of the present disclosure may be supported by the standard specifications, 3GPP TS 36.211, 3GPP TS 36.212, 3GPP TS 36.213, and 3GPP TS 36.321. That is, the steps or parts, which are not described to clearly reveal the technical idea of the present disclosure, in the embodiments of the present disclosure may be explained by the above standard specifications. All terms used in the embodiments of the present disclosure may be explained by the standard specifications.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the invention.

The following detailed description includes specific terms in order to provide a thorough understanding of the present disclosure. However, it will be apparent to those skilled in the art that the specific terms may be replaced with other terms without departing the technical spirit and scope of the present disclosure.

For example, the term used in embodiments of the present disclosure, TA is interchangeable with time advance, timing adjustment, or time adjustment in the same meaning.

The embodiments of the present disclosure can be applied to various wireless access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

CDMA may be implemented as a radio technology such as Universal Terrestrial Radio Access (UTRA) or CDMA2000. TDMA may be implemented as a radio technology such as Global System for Mobile communications (GSM)/General packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved UTRA (E-UTRA), etc.

UTRA is a part of Universal Mobile Telecommunications System (UMTS). 3GPP LTE is a part of Evolved UMTS (E-UMTS) using E-UTRA, adopting OFDMA for DL and SC-FDMA for UL. LTE-Advanced (LTE-A) is an evolution of 3GPP LTE. While the embodiments of the present disclosure are described in the context of a 3GPP LTE/LTE-A system in order to clarify the technical features of the present disclosure, the present disclosure is also applicable to an IEEE 802.16e/m system, etc.

1. 3GPP LTE/LTE-A System

In a wireless access system, a UE receives information from an eNB on a DL and transmits information to the eNB on a UL. The information transmitted and received between the UE and the eNB includes general data information and various types of control information. There are many physical channels according to the types/usages of information transmitted and received between the eNB and the UE.

1.1 System Overview

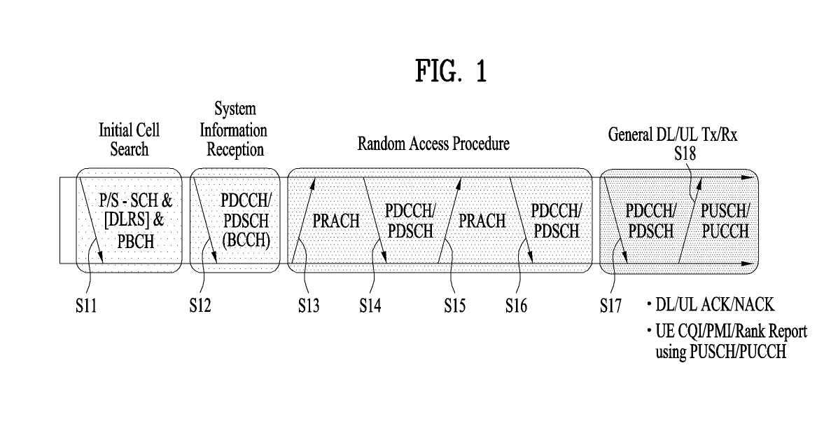

FIG. 1 illustrates physical channels and a general method using the physical channels, which may be used in embodiments of the present disclosure.

When a UE is powered on or enters a new cell, the UE performs initial cell search (S11). The initial cell search involves acquisition of synchronization to an eNB. Specifically, the UE synchronizes its timing to the eNB and acquires information such as a cell Identifier (ID) by receiving a Primary Synchronization Channel (P-SCH) and a Secondary Synchronization Channel (S-SCH) from the eNB.

Then the UE may acquire information broadcast in the cell by receiving a Physical Broadcast Channel (PBCH) from the eNB. During the initial cell search, the UE may monitor a DL channel state by receiving a Downlink Reference Signal (DL RS).

After the initial cell search, the UE may acquire more detailed system information by receiving a Physical Downlink Control Channel (PDCCH) and receiving a Physical Downlink Shared Channel (PDSCH) based on information of the PDCCH (S12).

To complete connection to the eNB, the UE may perform a random access procedure with the eNB (S13 to S16). In the random access procedure, the UE may transmit a preamble on a Physical Random Access Channel (PRACH) (S13) and may receive a PDCCH and a PDSCH associated with the PDCCH (S14). In the case of contention-based random access, the UE may additionally perform a contention resolution procedure including transmission of an additional PRACH (S15) and reception of a PDCCH signal and a PDSCH signal corresponding to the PDCCH signal (S16).

After the above procedure, the UE may receive a PDCCH and/or a PDSCH from the eNB (S17) and transmit a Physical Uplink Shared Channel (PUSCH) and/or a Physical Uplink Control Channel (PUCCH) to the eNB (S18), in a general UL/DL signal transmission procedure.

Control information that the UE transmits to the eNB is generically called Uplink Control Information (UCI). The UCI includes a Hybrid Automatic Repeat and reQuest Acknowledgement/Negative Acknowledgement (HARQ-ACK/NACK), a Scheduling Request (SR), a Channel Quality Indicator (CQI), a Precoding Matrix Index (PMI), a Rank Indicator (RI), etc.

In the LTE system, UCI is generally transmitted on a PUCCH periodically. However, if control information and traffic data should be transmitted simultaneously, the control information and traffic data may be transmitted on a PUSCH. In addition, the UCI may be transmitted aperiodically on the PUSCH, upon receipt of a request/command from a network.

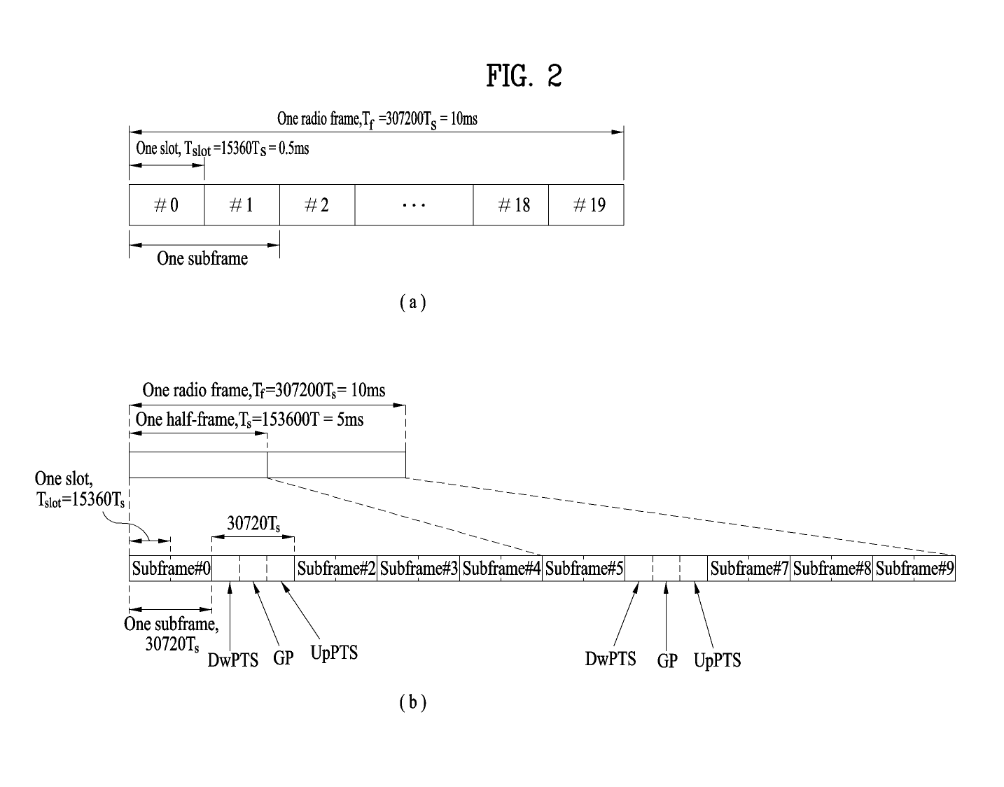

FIG. 2 illustrates exemplary radio frame structures used in embodiments of the present disclosure.

FIG. 2(a) illustrates frame structure type 1. Frame structure type 1 is applicable to both a full Frequency Division Duplex (FDD) system and a half FDD system.

One radio frame is 10 ms (T_{f}=307200·Tₛ) long, including equal-sized 20 slots indexed from 0 to 19. Each slot is 0.5 ms (Tₛₗₒₜ=15360·Tₛ) long. One subframe includes two successive slots. An iₜₕ subframe includes 2iₜₕ and (2i+1)ₜₕ slots. That is, a radio frame includes 10 subframes. A time required for transmitting one subframe is defined as a Transmission Time Interval (TTI). Ts is a sampling time given as Tₛ=1/(15 kHz×2048)=3.2552×10−8 (about 33 ns). One slot includes a plurality of Orthogonal Frequency Division Multiplexing (OFDM) symbols or SC-FDMA symbols in the time domain by a plurality of Resource Blocks (RBs) in the frequency domain.

A slot includes a plurality of OFDM symbols in the time domain. Since OFDMA is adopted for DL in the 3GPP LTE system, one OFDM symbol represents one symbol period. An OFDM symbol may be called an SC-FDMA symbol or symbol period. An RB is a resource allocation unit including a plurality of contiguous subcarriers in one slot.

In a full FDD system, each of 10 subframes may be used simultaneously for DL transmission and UL transmission during a 10-ms duration. The DL transmission and the UL transmission are distinguished by frequency. On the other hand, a UE cannot perform transmission and reception simultaneously in a half FDD system.

The above radio frame structure is purely exemplary. Thus, the number of subframes in a radio frame, the number of slots in a subframe, and the number of OFDM symbols in a slot may be changed.

FIG. 2(b) illustrates frame structure type 2. Frame structure type 2 is applied to a Time Division Duplex (TDD) system. One radio frame is 10 ms (T_{f}=307200·Tₛ) long, including two half-frames each having a length of 5 ms (=153600·Ts) long. Each half-frame includes five subframes each being 1ms (=30720·Tₛ) long. An iₜₕ subframe includes 2iₜₕ and (2i+1)ₜₕ slots each having a length of 0.5 ms (Tₛₗₒₜ=15360·Tₛ). Ts is a sampling time given as Tₛ=1/(15 kHz×2048)=3.2552×10−8 (about 33 ns).

A type-2 frame includes a special subframe having three fields, Downlink Pilot Time Slot (DwPTS), Guard Period (GP), and Uplink Pilot Time Slot (UpPTS). The DwPTS is used for initial cell search, synchronization, or channel estimation at a UE, and the UpPTS is used for channel estimation and UL transmission synchronization with a UE at an eNB. The GP is used to cancel UL interference between a UL and a DL, caused by the multi-path delay of a DL signal.

[Table 1] below lists special subframe configurations (DwPTS/GP/UpPTS lengths).

TABLE 1

| | Normal cyclic prefix in downlink | | | Extended cyclic prefix in downlink | | |
|---|---|---|---|---|---|---|
| | | UpPTS | | | UpPTS | |
| Special | | Normal | Extended | | | Extended |
| subframe | | cyclic prefix | cyclic prefix | | Normal cyclic | cyclic |
| configuration | DwPTS | in uplink | in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

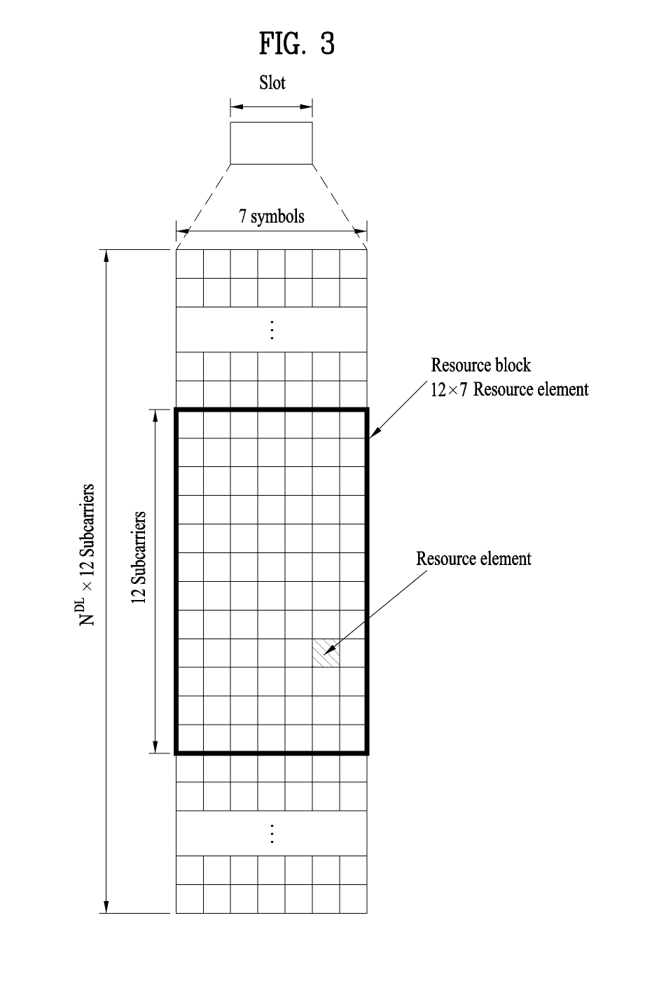

FIG. 3 illustrates an exemplary structure of a DL resource grid for the duration of one DL slot, which may be used in embodiments of the present disclosure.

Referring to FIG. 3, a DL slot includes a plurality of OFDM symbols in the time domain. One DL slot includes 7 OFDM symbols in the time domain and an RB includes 12 subcarriers in the frequency domain, to which the present disclosure is not limited.

Each element of the resource grid is referred to as a Resource Element (RE). An RB includes 12×7 REs. The number of RBs in a DL slot, NDL depends on a DL transmission bandwidth. A UL slot may have the same structure as a DL slot.

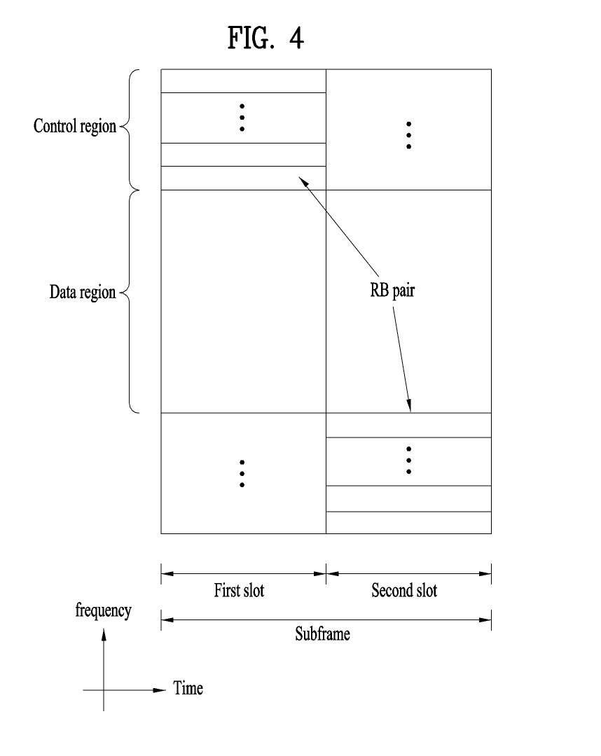

FIG. 4 illustrates a structure of a UL subframe which may be used in embodiments of the present disclosure.

Referring to FIG. 4, a UL subframe may be divided into a control region and a data region in the frequency domain. A PUCCH carrying UCI is allocated to the control region and a PUSCH carrying user data is allocated to the data region. To maintain a single carrier property, a UE does not transmit a PUCCH and a PUSCH simultaneously. A pair of RBs in a subframe are allocated to a PUCCH for a UE. The RBs of the RB pair occupy different subcarriers in two slots. Thus it is said that the RB pair frequency-hops over a slot boundary.

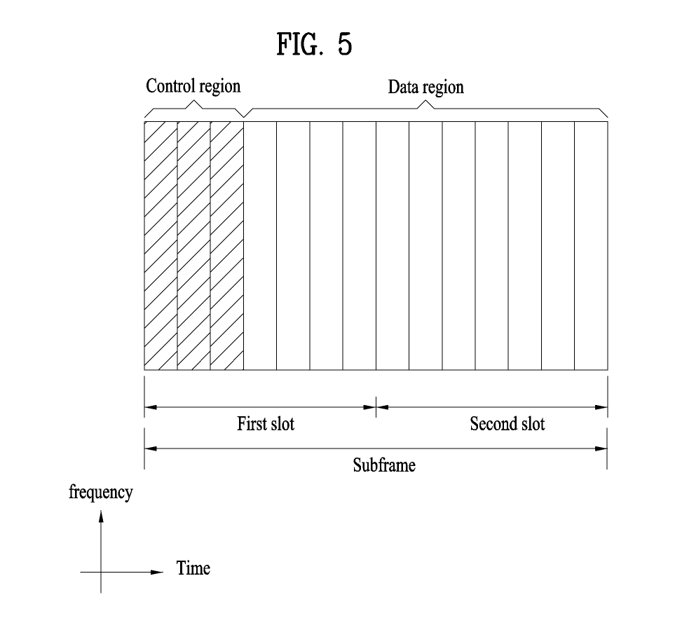

FIG. 5 illustrates a structure of a DL subframe that may be used in embodiments of the present disclosure.

Referring to FIG. 5, up to three OFDM symbols of a DL subframe, starting from OFDM symbol 0 are used as a control region to which control channels are allocated and the other OFDM symbols of the DL subframe are used as a data region to which a PDSCH is allocated. DL control channels defined for the 3GPP LTE system include a Physical Control Format Indicator Channel (PCFICH), a PDCCH, and a Physical Hybrid ARQ Indicator Channel (PHICH).

The PCFICH is transmitted in the first OFDM symbol of a subframe, carrying information about the number of OFDM symbols used for transmission of control channels (i.e. the size of the control region) in the subframe. The PHICH is a response channel to a UL transmission, delivering an HARQ ACK/NACK signal. Control information carried on the PDCCH is called Downlink Control Information (DCI). The DCI transports UL resource assignment information, DL resource assignment information, or UL Transmission (Tx) power control commands for a UE group.

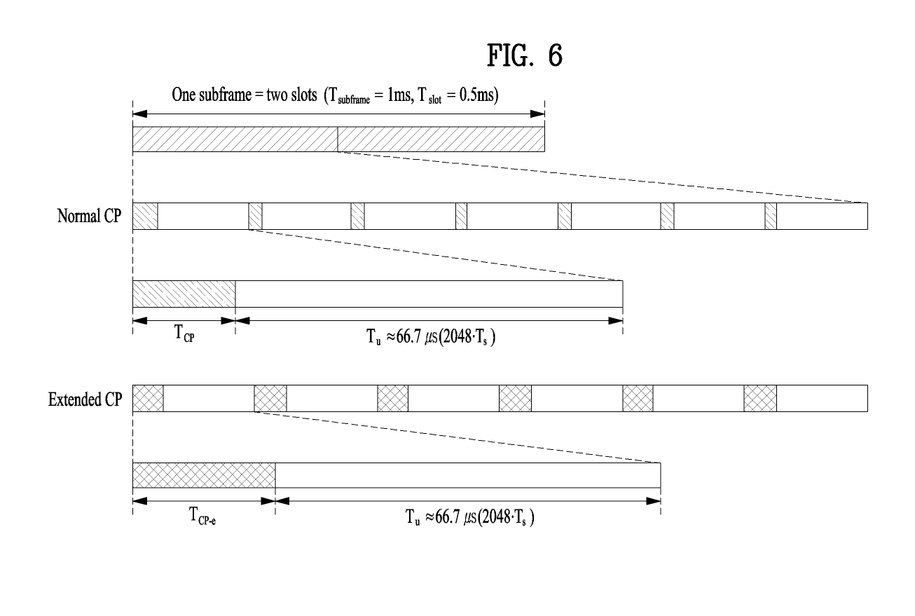

FIG. 6 is a diagram illustrating a configuration of a symbol that can be used in embodiments of the present invention.

The embodiments of the present invention can support two types of frame configurations as illustrated in FIG. 6 in order to support various scenarios of a cellular system by an LTE/LTE-A system.

An LTE/LTE-A system is designed to cover indoor, downtown, suburb, and province environments, and moving speed of a UE is considered as 350 to 500 km. In general, a center frequency at which an LTE/LTE-A system is managed is 400 MHz to 4 GHz and an available frequency band is 1.4 to 20 MHz. This means that delay spread and Doppler's frequency may be changed according to center frequency and available frequency band.

Referring to FIG. 6, in the case of normal cyclic prefix (CP), subcarrier spacing Δf=15 kHz and CP is about 4.7 us. In addition, in the case of extended CP, subcarrier spacing is the same and CP is about 16.7 us. The extended CP can support a wide range of cell installed in a relatively wide suburb or province due to a long CP duration.

In general, a cell installed in a suburb or a province has a long length of delay spread, an extended CP having a relatively long duration is necessary to definitely overcome inter-symbol interference (ISI). However, due to increase in relative overhead compared with a normal CP, trade-off whereby loss on spectral efficiency/transmission resource occurs is present.

Accordingly, in order to support all the cell arrangement scenarios, the LTE/LTE-A system fixes and uses values of normal CP/extended CP and uses the following design standard for determination of a length of a CP.

$$\begin{matrix}{T}_{CP} \geq {T}_{d} & to prevent \vert S \vert , \\ \frac{{f}_{dmax}}{Δ f} 1 & to keep \vert C \vert due to Doppler sufficiently low , \\ {T}_{CP} Δ f 1 & for spectral efficiency .\end{matrix}$$

In this case, T_{CP} refers to time duration of a CP, T_{d} refers to delay spread duration, and Δf refers to subcarrier spacing. In addition, f_{dmax} refers to a maximum Doppler spread value.

1.2 Physical Downlink Control Channel (PDCCH)

1.2.1 PDCCH Overview

The PDCCH may deliver information about resource allocation and a transport format for a Downlink Shared Channel (DL-SCH) (i.e. a DL grant), information about resource allocation and a transport format for an Uplink Shared Channel (UL-SCH) (i.e. a UL grant), paging information of a Paging Channel (PCH), system information on the DL-SCH, information about resource allocation for a higher-layer control message such as a random access response transmitted on the PDSCH, a set of Tx power control commands for individual UEs of a UE group, Voice Over Internet Protocol (VoIP) activation indication information, etc.

A plurality of PDCCHs may be transmitted in the control region. A UE may monitor a plurality of PDCCHs. A PDCCH is transmitted in an aggregate of one or more consecutive Control Channel Elements (CCEs). A PDCCH made up of one or more consecutive CCEs may be transmitted in the control region after subblock interleaving. A CCE is a logical allocation unit used to provide a PDCCH at a code rate based on the state of a radio channel. A CCE includes a plurality of RE Groups (REGs). The format of a PDCCH and the number of available bits for the PDCCH are determined according to the relationship between the number of CCEs and a code rate provided by the CCEs.

1.2.2 PDCCH Structure

A plurality of PDCCHs for a plurality of UEs may be multiplexed and transmitted in the control region. A PDCCH is made up of an aggregate of one or more consecutive CCEs. A CCE is a unit of 9 REGs each REG including 4 REs. Four Quadrature Phase Shift Keying (QPSK) symbols are mapped to each REG. REs occupied by RSs are excluded from REGs. That is, the total number of REGs in an OFDM symbol may be changed depending on the presence or absence of a cell-specific RS. The concept of an REG to which four REs are mapped is also applicable to other DL control channels (e.g. the PCFICH or the PHICH). Let the number of REGs that are not allocated to the PCFICH or the PHICH be denoted by NREG. Then the number of CCEs available to the system is NCCE (=└N_{REG}/9┘) and the CCEs are indexed from 0 to NCCE-1.

To simplify the decoding process of a UE, a PDCCH format including n CCEs may start with a CCE having an index equal to a multiple of n. That is, given CCE i, the PDCCH format may start with a CCE satisfying i mod n=0.

The eNB may configure a PDCCH with 1, 2, 4, or 8 CCEs. {1, 2, 4, 8} are called CCE aggregation levels. The number of CCEs used for transmission of a PDCCH is determined according to a channel state by the eNB. For example, one CCE is sufficient for a PDCCH directed to a UE in a good DL channel state (a UE near to the eNB). On the other hand, 8 CCEs may be required for a PDCCH directed to a UE in a poor DL channel state (a UE at a cell edge) in order to ensure sufficient robustness.

[Table 2] below illustrates PDCCH formats. 4 PDCCH formats are supported according to CCE aggregation levels as illustrated in [Table 2].

TABLE 2

| PDCCH | Number of | Number of | Number of |
|---|---|---|---|
| format | CCEs (n) | REGs | PDCCH bits |
| 0 | 1 | 9 | 72 |
| 1 | 2 | 18 | 144 |
| 2 | 4 | 36 | 288 |
| 3 | 8 | 72 | 576 |

A different CCE aggregation level is allocated to each UE because the format or Modulation and Coding Scheme (MCS) level of control information delivered in a PDCCH for the UE is different. An MCS level defines a code rate used for data coding and a modulation order. An adaptive MCS level is used for link adaptation. In general, three or four MCS levels may be considered for control channels carrying control information.

Regarding the formats of control information, control information transmitted on a PDCCH is called DCI. The configuration of information in PDCCH payload may be changed depending on the DCI format. The PDCCH payload is information bits. [Table 3] lists DCI according to DCI formats.

TABLE 3

| DCI | |
|---|---|
| Format | Description |
| Format 0 | Resource grants for the PUSCH transmissions (uplink) |
| Format 1 | Resource assignments for single codeword PDSCH |
| | transmissions (transmission modes 1, 2 and 7) |
| Format 1A | Compact signaling of resource assignments for single |
| | codeword PDSCH (all modes) |
| Format 1B | Compact resource assignments for PDSCH using rank-1 |
| | closed loop precoding (mode 6) |
| Format 1C | Very compact resource assignments for PDSCH |
| | (e.g. paging/broadcast system information) |
| Format 1D | Compact resource assignments for PDSCH using multi-user |
| | MIMO (mode 5) |
| Format 2 | Resource assignments for PDSCH for closed-loop MIMO |
| | operation (mode 4) |
| Format 2A | Resource assignments for PDSCH for open-loop MIMO |
| | operation (mode 3) |
| Format | Power control commands for PUCCH and PUSCH with |
| 3/3A | 2-bit/1-bit power adjustment |
| Format 4 | Scheduling of PUSCH in one UL cell with multi-antenna port |
| | transmission mode |

Referring to [Table 3], the DCI formats include Format 0 for PUSCH scheduling, Format 1 for single-codeword PDSCH scheduling, Format 1A for compact single-codeword PDSCH scheduling, Format 1C for very compact DL-SCH scheduling, Format 2 for PDSCH scheduling in a closed-loop spatial multiplexing mode, Format 2A for PDSCH scheduling in an open-loop spatial multiplexing mode, and Format 3/3A for transmission of Transmission Power Control (TPC) commands for uplink channels. DCI Format 1A is available for PDSCH scheduling irrespective of the transmission mode of a UE.

The length of PDCCH payload may vary with DCI formats. In addition, the type and length of PDCCH payload may be changed depending on compact or non-compact scheduling or the transmission mode of a UE.

The transmission mode of a UE may be configured for DL data reception on a PDSCH at the UE. For example, DL data carried on a PDSCH includes scheduled data, a paging message, a random access response, broadcast information on a BCCH, etc. for a UE. The DL data of the PDSCH is related to a DCI format signaled through a PDCCH. The transmission mode may be configured semi-statically for the UE by higher-layer signaling (e.g. Radio Resource Control (RRC) signaling). The transmission mode may be classified as single antenna transmission or multi-antenna transmission.

A transmission mode is configured for a UE semi-statically by higher-layer signaling. For example, multi-antenna transmission scheme may include transmit diversity, open-loop or closed-loop spatial multiplexing, Multi-User Multiple Input Multiple Output (MU-MIMO), or beamforming Transmit diversity increases transmission reliability by transmitting the same data through multiple Tx antennas. Spatial multiplexing enables high-speed data transmission without increasing a system bandwidth by simultaneously transmitting different data through multiple Tx antennas. Beamforming is a technique of increasing the Signal to Interference plus Noise Ratio (SINR) of a signal by weighting multiple antennas according to channel states.

A DCI format for a UE depends on the transmission mode of the UE. The UE has a reference DCI format monitored according to the transmission mode configure for the UE. The following 10 transmission modes are available to UEs:
Transmission mode 1: Single antenna transmission
Transmission mode 2: Transmission diversity
Transmission mode 3: Open-loop codebook based precoding when the number of layer is greater than 1, Transmission diversity when the number of rank is 1
Transmission mode 4: closed-loop codebook based precoding
Transmission mode 5: Multi-user MIMO of transmission mode 4 version
Transmission mode 6: closed-loop codebook based precoding which is specifically limited for signal layer transmission
Transmission mode 7: precoding dose not based on codebooks only supporting single layer transmission (release 8)
Transmission mode 8: precoding dose not based on codebooks supporting maximum 2 layers (release 9)
Transmission mode 9: precoding dose not based on codebooks supporting maximum 8 layers (release 10)

1.2.3 PDCCH Transmission

The eNB determines a PDCCH format according to DCI that will be transmitted to the UE and adds a Cyclic Redundancy Check (CRC) to the control information. The CRC is masked by a unique Identifier (ID) (e.g. a Radio Network Temporary Identifier (RNTI)) according to the owner or usage of the PDCCH. If the PDCCH is destined for a specific UE, the CRC may be masked by a unique ID (e.g. a cell-RNTI (C-RNTI)) of the UE. If the PDCCH carries a paging message, the CRC of the PDCCH may be masked by a paging indicator ID (e.g. a Paging-RNTI (P-RNTI)). If the PDCCH carries system information, particularly, a System Information Block (SIB), its CRC may be masked by a system information ID (e.g. a System Information RNTI (SI-RNTI)). To indicate that the PDCCH carries a random access response to a random access preamble transmitted by a UE, its CRC may be masked by a Random Access-RNTI (RA-RNTI).

Then the eNB generates coded data by channel-encoding the CRC-added control information. The channel coding may be performed at a code rate corresponding to an MCS level. The eNB rate-matches the coded data according to a CCE aggregation level allocated to a PDCCH format and generates modulation symbols by modulating the coded data. Herein, a modulation order corresponding to the MCS level may be used for the modulation. The CCE aggregation level for the modulation symbols of a PDCCH may be one of 1, 2, 4, and 8. Subsequently, the eNB maps the modulation symbols to physical REs (i.e. CCE to RE mapping).

1.2.4 Blind Decoding (BD)

A plurality of PDCCHs may be transmitted in a subframe. That is, the control region of a subframe includes a plurality of CCEs, CCE 0 to CCE NCCE,k-1. NCCE,k is the total number of CCEs in the control region of a kth subframe. A UE monitors a plurality of PDCCHs in every subframe. This means that the UE attempts to decode each PDCCH according to a monitored PDCCH format.

The eNB does not provide the UE with information about the position of a PDCCH directed to the UE in an allocated control region of a subframe. Without knowledge of the position, CCE aggregation level, or DCI format of its PDCCH, the UE searches for its PDCCH by monitoring a set of PDCCH candidates in the subframe in order to receive a control channel from the eNB. This is called blind decoding. Blind decoding is the process of demasking a CRC part with a UE ID, checking a CRC error, and determining whether a corresponding PDCCH is a control channel directed to a UE by the UE.

The UE monitors a PDCCH in every subframe to receive data transmitted to the UE in an active mode. In a Discontinuous Reception (DRX) mode, the UE wakes up in a monitoring interval of every DRX cycle and monitors a PDCCH in a subframe corresponding to the monitoring interval. The PDCCH-monitored subframe is called a non-DRX subframe.

To receive its PDCCH, the UE should blind-decode all CCEs of the control region of the non-DRX subframe. Without knowledge of a transmitted PDCCH format, the UE should decode all PDCCHs with all possible CCE aggregation levels until the UE succeeds in blind-decoding a PDCCH in every non-DRX subframe. Since the UE does not know the number of CCEs used for its PDCCH, the UE should attempt detection with all possible CCE aggregation levels until the UE succeeds in blind decoding of a PDCCH.

In the LTE system, the concept of Search Space (SS) is defined for blind decoding of a UE. An SS is a set of PDCCH candidates that a UE will monitor. The SS may have a different size for each PDCCH format. There are two types of SSs, Common Search Space (CSS) and UE-specific/Dedicated Search Space (USS).

While all UEs may know the size of a CSS, a USS may be configured for each individual UE. Accordingly, a UE should monitor both a CSS and a USS to decode a PDCCH. As a consequence, the UE performs up to 44 blind decodings in one subframe, except for blind decodings based on different CRC values (e.g., C-RNTI, P-RNTI, SI-RNTI, and RA-RNTI).

In view of the constraints of an SS, the eNB may not secure CCE resources to transmit PDCCHs to all intended UEs in a given subframe. This situation occurs because the remaining resources except for allocated CCEs may not be included in an SS for a specific UE. To minimize this obstacle that may continue in the next subframe, a UE-specific hopping sequence may apply to the starting point of a USS.

[Table 4] illustrates the sizes of CSSs and USSs.

TABLE 4

| | Number of | | |
|---|---|---|---|
| PDCCH | CCEs | Number of candidates | Number of candidates |
| format | (n) | in common search space | in dedicated search space |
| 0 | 1 | — | 6 |
| 1 | 2 | — | 6 |
| 2 | 4 | 4 | 2 |
| 3 | 8 | 2 | 2 |

To mitigate the load of the UE caused by the number of blind decoding attempts, the UE does not search for all defined DCI formats simultaneously. Specifically, the UE always searches for DCI Format 0 and DCI Format 1A in a USS. Although DCI Format 0 and DCI Format 1A are of the same size, the UE may distinguish the DCI formats by a flag for format0/format 1a differentiation included in a PDCCH. Other DCI formats than DCI Format 0 and DCI Format 1A, such as DCI Format 1, DCI Format 1B, and DCI Format 2 may be required for the UE.

The UE may search for DCI Format 1A and DCI Format 1C in a CSS. The UE may also be configured to search for DCI Format 3 or 3A in the CSS. Although DCI Format 3 and DCI Format 3A have the same size as DCI Format 0 and DCI Format 1A, the UE may distinguish the DCI formats by a CRC scrambled with an ID other than a UE-specific ID.

An SS Sₖ^{(L)} is a PDCCH candidate set with a CCE aggregation level L ∈{1,2,4,8}. The CCEs of PDCCH candidate set m in the SS may be determined by the following equation.

L·{(Yₖ+m)mod└N_{CCE,k}/L┘}+i [Equation 1]

where M^{(L)} is the number of PDCCH candidates with CCE aggregation level L to be monitored in the SS, m=0, . . . , M^{(L)}−1, i is the index of a CCE in each PDCCH candidate, and i=0, . . . , L−1 , k=└nₛ/2┘ where nₛ is the index of a slot in a radio frame.

As described before, the UE monitors both the USS and the CSS to decode a PDCCH. The CSS supports PDCCHs with CCE aggregation levels {4, 8} and the USS supports PDCCHs with CCE aggregation levels {1, 2, 4, 8}. [Table 5] illustrates PDCCH candidates monitored by a UE.

TABLE 5

| Search space Sₖ^{(L)} | | | Number of PDCCH |
|---|---|---|---|
| Type | Aggregation level L | Size [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

Referring to [Equation 1], for two aggregation levels, L=4 and L=8, Yₖ is set to 0 in the CSS, whereas Yₖ is defined by [Equation 2] for aggregation level L in the USS.

Yₖ=(A·Yₖ₋₁)mod D [Equation 2]

where Y₋₁=n_{RNTI}≠0, n_{RNTI} indicating an RNTI value. A=39827 and D=65537.

1.3 Reference Signal (RS)

Hereinafter, reference signals that can be used in embodiments of the present invention will be described.

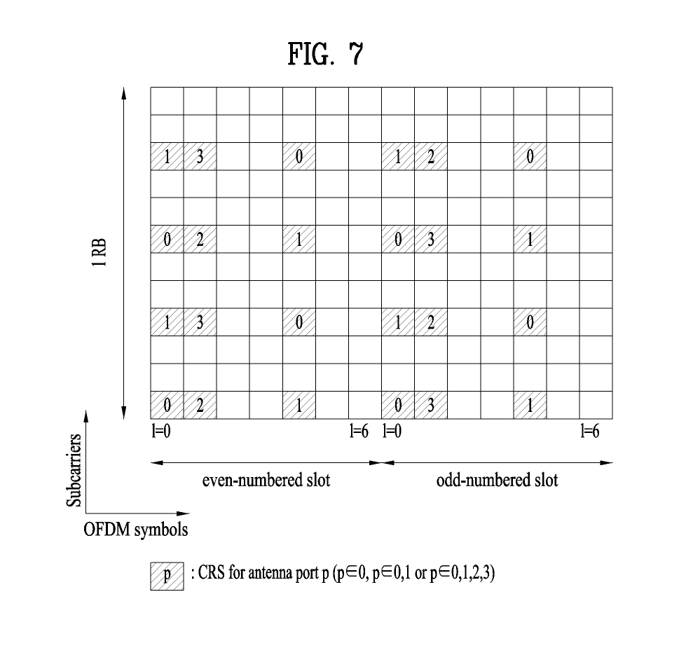

FIG. 7 is a diagram illustrating an example of a subframe to which a cell specific reference signal (CRS) is allocated, which can be used in embodiments of the present invention.

FIG. 7 illustrates an allocation structure of the CRS when the system supports 4 antenna. In an existing 3GPP LTE/LTE-A system, since CRSs are used for both demodulation and measurement, the CRSs are transmitted in all DL subframes in a cell supporting PDSCH transmission and are transmitted through all antenna ports configured at an eNB.

More specifically, CRS sequence r_{l,n}_{ₛ}(m) is mapped to complex-valued modulation symbols a_{k,l}^{(p)} used as reference symbols for antenna port p in slot ns according to the following Equation 3.

a_{k,l}^{(p)}=r_{l,n}_{ₛ}(m′) [Equation 3]

Where nₛ is the slot number in a radio frame, and 1 is the OFDM symbol number within the slot, which is determined according to the following Equation 4.

$$k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 \\ {m}^{′} = m + {N}_{RB}^{max , DL} - {N}_{RB}^{DL} \qquad [ Equation 4 ]$$

Where k denotes a subcarrier index, 1 denotes an OFDM symbol index, and N_{R}^{max,DL} denotes the largest DL bandwidth configuration, expressed as an integer multiple of N_{SC}^{RB}. Parameters v and v_{shift} define locations for different RSs in the frequency domain and v is given as follows.

$$v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3\end{matrix} \qquad [ Equation 5 ]$$

The cell-specific frequency shift v_{shift} is given by a physical layer cell identity N_{ID}^{cell} as follows.

V_{shift}=N_{ID}^{cell} mod6 [Equation 6]

A UE may measure CSI using the CRSs and demodulate a signal received on a PDSCH in a subframe including the CRSs. That is, the eNB transmits the CRSs at predetermined locations in each RB of all RBs and the UE performs channel estimation based on the CRSs and detects the PDSCH. For example, the UE may measure a signal received on a CRS RE and detect a PDSCH signal from an RE to which the PDSCH is mapped using the measured signal and using the ratio of reception energy per CRS RE to reception energy per PDSCH mapped RE.

When the PDSCH is transmitted based on the CRSs, since the eNB should transmit the CRSs in all RBs, unnecessary RS overhead occurs. To solve such a problem, in a 3GPP LTE-A system, a UE-specific RS (hereinafter, UE-RS) and a CSI-RS are further defined in addition to a CRS. The UE-RS is used for demodulation and the CSI-RS is used to derive CSI. The UE-RS is one type of a DRS.

Since the UE-RS and the CRS may be used for demodulation, the UE-RS and the CRS can be regarded as demodulation RSs in terms of usage. Since the CSI-RS and the CRS are used for channel measurement or channel estimation, the CSI-RS and the CRS can be regarded as measurement RSs.

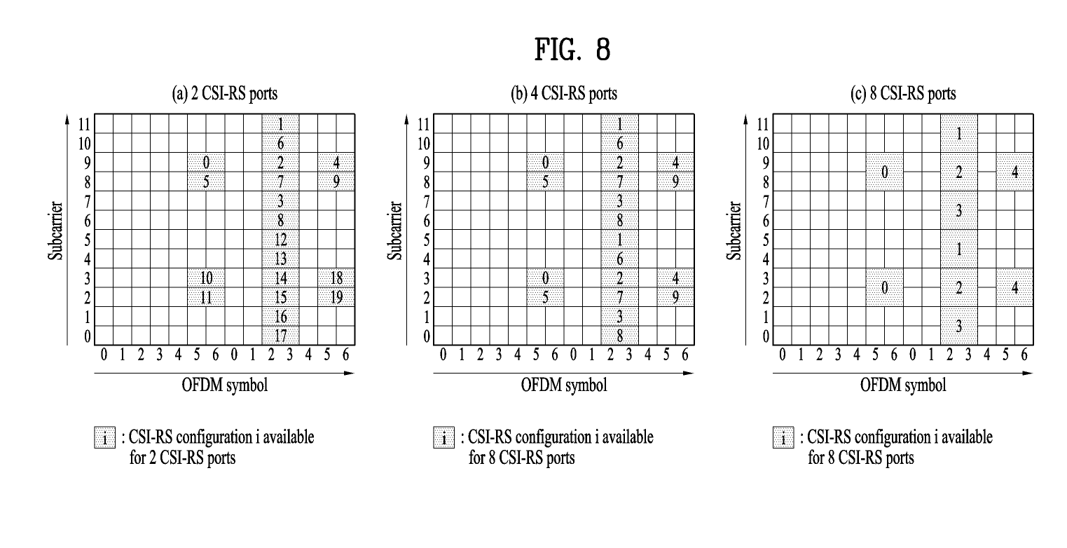

FIG. 8 is a diagram illustrating an example of subframes in which CSI-RSs that can be used in embodiments of the present invention are allocated according to the number of antenna ports.

A CSI-RS is a DL RS that is introduced in a 3GPP LTE-A system for channel measurement rather than for demodulation. In the 3GPP LTE-A system, a plurality of CSI-RS configurations is defined for CSI-RS transmission. In subframes in which CSI-RS transmission is configured, CSI-RS sequence r_{l,n} (m) is mapped to complex modulation symbols a_{k,l}^{(p)} used as RSs on antenna port p according to the following Equation 7.

a_{k,l}^{(p)}=w_{l″}·r_{l,n}_{ₛ}(m′) [Equation 7]

where W_{l″}, k, l are given by the following Equation 8.

$$k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix \\ - 0 & for p ∈ \{ 15 , 16 \} , extended cyclic prefix \\ - 3 & for p ∈ \{ 17 , 18 \} , extended cyclic prefix \\ - 6 & for p ∈ \{ 19 , 20 \} , extended cyclic prefix \\ - 9 & for p ∈ \{ 21 , 22 \} , extended cyclic prefix\end{matrix} \\ l = {l}^{′} + \{ \begin{matrix}{l}^{″} & \begin{matrix}CSI reference signal configurations 0 \text{-} 19 , \\ normal cyclic prefix\end{matrix} \\ 2 {l}^{″} & \begin{matrix}CSI reference signal configurations 20 \text{-} 31 , \\ normal cyclic prefix\end{matrix} \\ {l}^{″} & \begin{matrix}CSI reference signal configurations 0 \text{-} 27 , \\ extended cyclic prefix\end{matrix}\end{matrix} \\ {w}_{{l}^{″}} = \{ \begin{matrix}1 & p ∈ \{ 15 , 17 , 19 , 21 ) \\ {( - 1 )}^{{l}^{″}} & p ∈ \{ 16 , 18 , 20 , 22 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋ \qquad [ Equation 8 ]$$

Where (k′, l′) and necessary conditions on ns are given by Table 6 and Table 7 in a normal CP and an extended CP, respectively. That is, CSI-RS configurations of Table 6 and Table 7 denote locations of REs occupied by a CSI-RS of each antenna port in an RB pair.

TABLE 6

| | | Number of CSI reference signals configured | | | | | |
|---|---|---|---|---|---|---|---|
| | CSI reference signal | 1 or 2 | | 4 | | 8 | |
| | configuration | (k′, l′) | nₛ mod 2 | (k′, l′) | nₛ mod 2 | (k′, l′) | nₛ mod 2 |
| FS1 | 0 | (9, 5) | 0 | (9, 5) | 0 | (9, 5) | 0 |
| and | 1 | (11, 2) | 1 | (11, 2) | 1 | (11, 2) | 1 |
| FS2 | 2 | (9, 2) | 1 | (9, 2) | 1 | (9, 2) | 1 |
| | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| | 17 | (0, 2) | 1 | | | | |
| | 18 | (3, 5) | 1 | | | | |
| | 19 | (2, 5) | 1 | | | | |
| FS2 | 20 | (11, 1) | 1 | (11, 1) | 1 | (11, 1) | 1 |
| only | 21 | (9, 1) | 1 | (9, 1) | 1 | (9, 1) | 1 |
| | 22 | (7, 1) | 1 | (7, 1) | 1 | (7, 1) | 1 |
| | 23 | (10, 1) | 1 | (10, 1) | 1 | | |
| | 24 | (8, 1) | 1 | (8, 1) | 1 | | |
| | 25 | (6, 1) | 1 | (6, 1) | 1 | | |
| | 26 | (5, 1) | 1 | | | | |
| | 27 | (4, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

TABLE 7

| | CSI reference | Number of CSI reference signals configured | | | | | |
|---|---|---|---|---|---|---|---|
| | signal | 1 or 2 | | 4 | | 8 | |
| | configuration | (k′, l′) | nₛ mod 2 | (k′, l′) | nₛ mod 2 | (k′, l′) | nₛ mod 2 |
| FS1 and | 0 | (11, 4) | 0 | (11, 4) | 0 | (11, 4) | 0 |
| FS2 | 1 | (9, 4) | 0 | (9, 4) | 0 | (9, 4) | 0 |
| | 2 | (10, 4) | 1 | (10, 4) | 1 | (10, 4) | 1 |
| | 3 | (9, 4) | 1 | (9, 4) | 1 | (9, 4) | 1 |
| | 4 | (5, 4) | 0 | (5, 4) | 0 | | |
| | 5 | (3, 4) | 0 | (3, 4) | 0 | | |
| | 6 | (4, 4) | 1 | (4, 4) | 1 | | |
| | 7 | (3, 4) | 1 | (3, 4) | 1 | | |
| | 8 | (8, 4) | 0 | | | | |
| | 9 | (6, 4) | 0 | | | | |
| | 10 | (2, 4) | 0 | | | | |
| | 11 | (0, 4) | 0 | | | | |
| | 12 | (7, 4) | 1 | | | | |
| | 13 | (6, 4) | 1 | | | | |
| | 14 | (1, 4) | 1 | | | | |
| | 15 | (0, 4) | 1 | | | | |
| FS2 | 16 | (11, 1) | 1 | (11, 1) | 1 | (11, 1) | 1 |
| only | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| | 20 | (4, 1) | 1 | (4, 1) | 1 | | |
| | 21 | (3, 1) | 1 | (3, 1) | 1 | | |
| | 22 | (8, 1) | 1 | | | | |
| | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

FIG. 8(a) illustrates 20 CSI-RS configurations 0 to 19 available for CSI-RS transmission through two CSI-RS ports among the CSI-RS configurations of Table 6, FIG. 8(b) illustrates 10 available CSI-RS configurations 0 to 9 through four CSI-RS ports among the CSI-RS configurations of Table 6, and FIG. 8(c) illustrates 5 available CSI-RS configurations 0 to 4 through 8 CSI-RS ports among the CSI-RS configurations of Table 6.

The CSI-RS ports refer to antenna ports configured for CSI-RS transmission. For example, referring to Equation 8, antenna ports 15 to 22 correspond to the CSI-RS ports. Since CSI-RS configuration differs according to the number of CSI-RS ports, if the numbers of antenna ports configured for CSI-RS transmission differ, the same CSI-RS configuration number may correspond to different CSI-RS configurations.

Unlike a CRS configured to be transmitted in every subframe, a CSI-RS is configured to be transmitted at a prescribed period corresponding to a plurality of subframes. Accordingly, CSI-RS configurations vary not only with the locations of REs occupied by CSI-RSs in an RB pair according to Table 6 or Table 7 but also with subframes in which CSI-RSs are configured.

Meanwhile, if subframes for CSI-RS transmission differ even when CSI-RS configuration numbers are the same in Table 6 or Table 7, CSI-RS configurations also differ. For example, if CSI-RS transmission periods (_{TCSI-RS}) differ or if start subframes (Δ_{CSI-RS}) in which CSI-RS transmission is configured in one radio frame differ, this may be considered as different CSI-RS configurations.

Hereinafter, in order to distinguish between a CSI-RS configuration to which (1) a CSI-RS configuration number of Table 6 or Table 7 is assigned and (2) a CSI-RS configuration varying according to a CSI-RS configuration number of Table 6 or Table 7, the number of CSI-RS ports, and/or a CSI-RS configured subframe, the CSI-RS configuration of the latter will be referred to as a CSI-RS resource configuration. The CSI-RS configuration of the former will be referred to as a CSI-RS configuration or CSI-RS pattern.

Upon informing a UE of the CSI-RS resource configuration, an eNB may inform the UE of information about the number of antenna ports used for transmission of CSI-RSs, a CSI-RS pattern, CSI-RS subframe configuration ICSI-RS, UE assumption on reference PDSCH transmitted power for CSI feedback Pc, a zero-power CSI-RS configuration list, a zero-power CSI-RS subframe configuration, etc.

CSI-RS subframe configuration I_{CSI-RS} is information for specifying subframe configuration periodicity T_{CSI-RS} and subframe offset Δ_{CSI-RS} regarding occurrence of the CSI-RSs. The following table 8 shows CSI-RS subframe configuration I_{CSI-RS} according to T_{CSI-RS} and Δ_{CSI-RS}.

TABLE 12

| | CSI-RS periodicity | CSI-RS subframe offset |
|---|---|---|
| CSI-RS-SubframeConfig | TCSI-RS | ΔCSI-RS |
| ICSI-RS | (subframes) | (subframes) |
| 0-4 | 5 | ICSI-RS |
| 5-14 | 10 | ICSI-RS - 5 |
| 15-34 | 20 | ICSI-RS - 15 |
| 35-74 | 40 | ICSI-RS - 35 |
| 75-154 | 80 | ICSI-RS - 75 |

Subframes satisfying the following Equation 8 are subframes including CSI-RSs.

10n_{f}+└nₛ/2┘−Δ_{CSI-RS})mod T_{CSI-RS}=0 [Equation 8]

A UE configured as transmission modes defined after introduction of the 3GPP LTE-A system (e.g. transmission mode 9 or other newly defined transmission modes) may perform channel measurement using a CSI-RS and decode a PDSCH using a UE-RS.

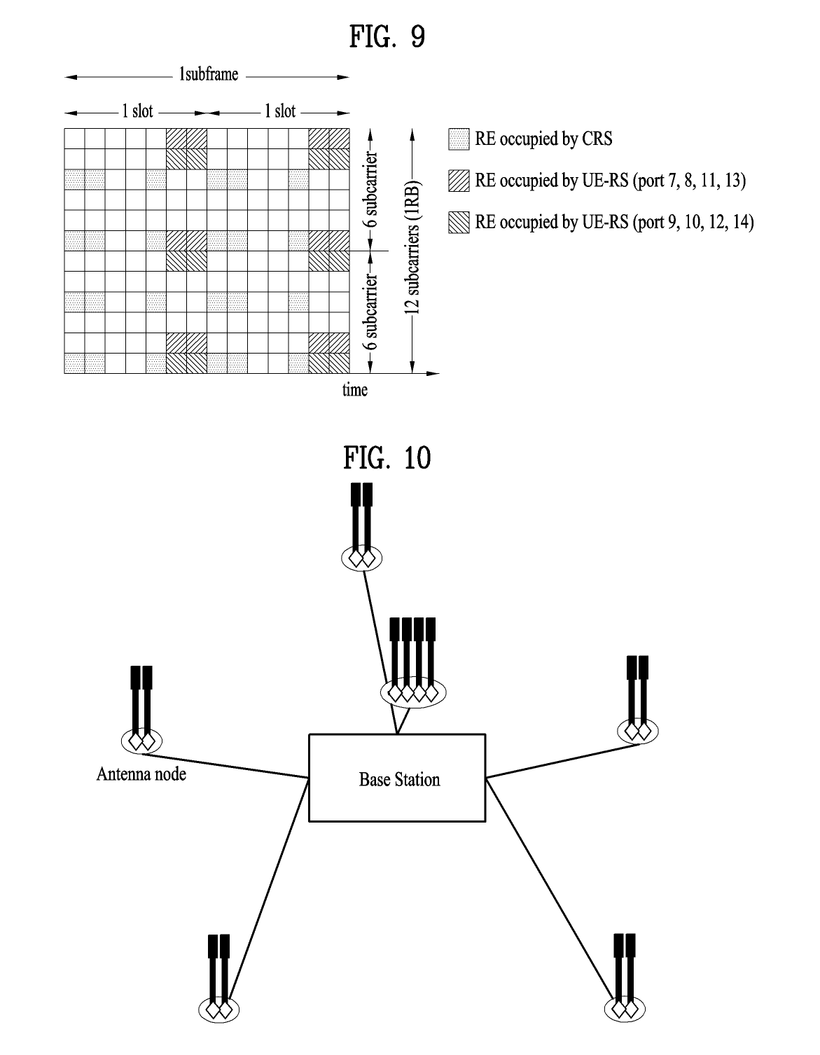

FIG. 9 is a diagram illustrating an example of UE-specific reference signals (UE-RSs) that can be used in embodiments of the present invention.

Referring to FIG. 9, the subframe illustrates REs occupied by UE-RSs among REs in one RB of a normal DL subframe having a normal CP.

UE-RSs are transmitted on antenna port(s) p=5, p=7, p=8 or p=7, 8, . . . , υ+6 for PDSCH transmission, where υ is the number of layers used for the PDSCH transmission. UE-RSs are present and are a valid reference for PDSCH demodulation only if the PDSCH transmission is associated with the corresponding antenna port. UE-RSs are transmitted only on RBs to which the corresponding PDSCH is mapped.

The UE-RSs are configured to be transmitted only on RB(s) to which a PDSCH is mapped in a subframe in which the PDSCH is scheduled unlike CRSs configured to be transmitted in every subframe irrespective of whether the PDSCH is present. Accordingly, overhead of the RS may decrease relative to overhead of the CRS.

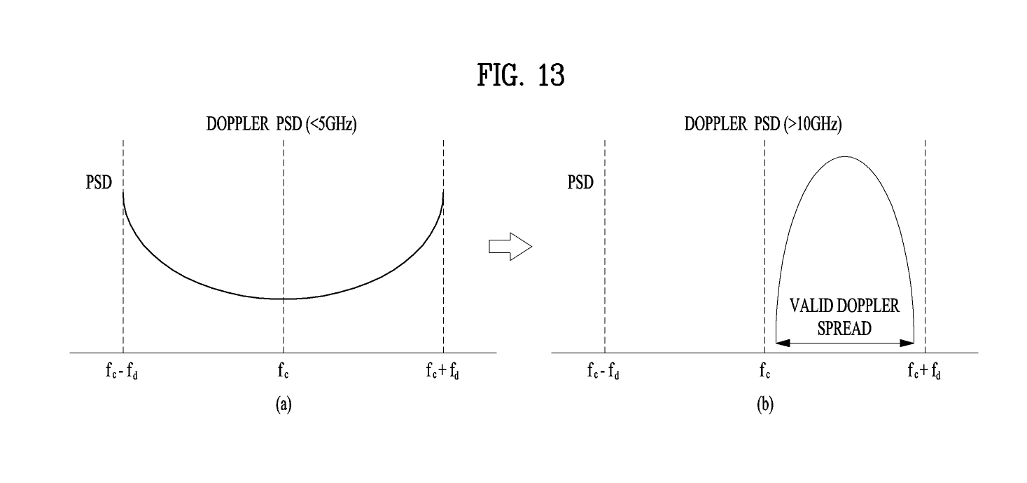

In the 3GPP LTE-A system, the UE-RSs are defined in a PRB pair. Referring to FIG. 13, in a PRB having frequency-domain index nPRB assigned for PDSCH transmission with respect to p=7, p=8, or p=7, 8, . . . , υ+6, a part of UE-RS sequence r(m) is mapped to complex-valued modulation symbols a_{k,l}^{(p)} in a subframe according to the following Equation 9.

a_{k,l}^{(p)}=wₚ(l′)·r(3·1′·N_{RB}^{max,DL}+3·n_{PRB}+m′) [Equation 9]

where wₚ(i), l′, m′ are given as following Equation 14.

$${w}_{p} ( i ) = \{ \begin{matrix}{\overline{w}}_{p} ( i ) & ( {m}^{′} + {n}_{PRB} ) mod 2 = 0 \\ {\overline{w}}_{p} ( 3 - i ) & ( {m}^{′} + {n}_{PRB} ) mod 2 = 1\end{matrix} \\ k = 5 {m}^{′} + {N}_{sc}^{RB} {n}_{PRB} + {k}^{′} \\ {k}^{′} = \{ \begin{matrix}1 & p ∈ \{ 7 , 8 , 11 , 13 \} \\ 0 & p ∈ \{ 9 , 10 , 12 , 14 \}\end{matrix} \\ l = \{ \begin{matrix}{l}^{′} mod 2 + 2 & \begin{matrix}if in a special subframe with configuration \\ 3 , 4 , or 8 ( See Table 2 )\end{matrix} \\ {l}^{′} mod 2 + 2 + 3 ⌊ {l}^{′} \text{/} 2 ⌋ & \begin{matrix}if in a special subframe with configuration \\ 1 , 2 , 6 , or 7 ( See Table 2 )\end{matrix} \\ {l}^{′} mod 2 + 5 & if not in a special subframe\end{matrix} \\ {l}^{′} = \{ \begin{matrix}0 , 1 , 2 , 3 & \begin{matrix}if {n}_{s} mod 2 = 0 and in a special subrame with \\ configuration 1 , 2 , 6 , or 7 ( See Table 2 )\end{matrix} \\ 0 , 1 & \begin{matrix}if {n}_{s} mod 2 = 0 and not in special subrame with \\ configuration 1 , 2 , 6 , or 7 ( See Table 2 )\end{matrix} \\ 2 , 3 & \begin{matrix}if {n}_{s} mod 2 = 1 and not in special subrame with \\ configuration 1 , 2 , 6 , or 7 ( See Table 2 )\end{matrix}\end{matrix} \\ {m}^{′} = 0 , 1 , 2 \qquad [ Equation 14 ]$$

where the sequence w̅ₚ(i) for the normal CP is given according to the following table 8.

TABLE 8

| Antenna port p | [ w̅ₚ(0) w̅ₚ(1) w̅ₚ(2) w̅ₚ(3)] |
|---|---|
| 7 | [+1 +1 +1 +1] |
| 8 | [+1 −1 +1 −1] |
| 9 | [+1 +1 +1 +1] |
| 10 | [+1 −1 +1 −1] |
| 11 | [+1 +1 −1 −1] |
| 12 | [−1 −1 +1 +1] |
| 13 | [+1 −1 −1 +1] |
| 14 | [−1 +1 +1 −1] |

For antenna port p ∈{7, 8, . . . , υ+6}, the UE-RS sequence r(m) is defined as following Equation 15.

$$r ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = \{ \begin{matrix}0 , 1 , … , 12 {N}_{RB}^{max , DL} - 1 & normal cyclic prefix \\ 0 , 1 , … , 16 {N}_{RB}^{max , DL} - 1 & extended cyclic prefix\end{matrix} \qquad [ Equation 15 ]$$

c(i) is a pseudo-random sequence defined by a length-31 Gold sequence. The output sequence c(n) of length MPN, where n=0, 1, . . . , MPN-1, is defined by the following Equation 16.

c(n)=(x₁(n+N_{C})+x₂(n+N_{C}))mod2

x₁(n+31)=(x₁(n+3)+x₁(n)mod2

x₂(n+31)=(x₂(n+3)+x₂(n+2)+x₂(n+1)+x₂(n))mod2 [Equation 16]

Where N_{C}=1600 and the first m-sequence is initialized with x₁(0)=1, x₁(n)=0, n=1, 2, . . . , 30. The initialization of the second m-sequence is denoted by cᵢₙᵢₜ=Σᵢ₌₀³⁰x₂(i)·2ⁱ with the value depending on the application of the sequence.

In Equation 16, the pseudo-random sequence generator for generating c(i) is initialized with cᵢₙᵢₜ at the start of each subframe according to the following Equation 17.

cᵢₙᵢₜ=(└nₛ/2┘+1)·(2N_{ID}^{cell}+1)·2¹⁶+n_{SCID} [Equation 17]

Where n_{SCID} is 0 unless specified otherwise and is given by DCI format 2B or 2C associated with PDSCH transmission with respect to PDSCH transmission on antenna port 7 or 8. DCI format 2B is a DCI format for resource assignment for a PDSCH using a maximum of two antenna ports having UE-RSs. DCI format 2C is a DCI format for resource assignment for a PDSCH using a maximum of 8 antenna ports having UE-RSs.

As can be appreciated from Equations 12 to 16, UE-RSs are transmitted through antenna port(s) corresponding respectively to layer(s) of a PDSCH. That is, according to Equations 12 to 16, the number of UE-RS ports is proportional to a transmission rank of the PDSCH. Meanwhile, if the number of layers is 1 or 2, 12 REs per RB pair are used for UE-RS transmission and, if the number of layers is greater than 2, 24 REs per RB pair are used for UE-RS transmission. In addition, locations of REs occupied by UE-RSs (i.e. locations of UE-RS REs) in a PR pair are the same with respect to a UE-RS port regardless of a UE or a cell.

As a result, the number of DMRS REs in an RB to which a PDSCH for a specific UE in a specific subframe is mapped is the same. Notably, in RBs to which the PDSCH for different UEs in the same subframe is allocated, the number of DMRS REs included in the RBs may differ according to the number of transmitted layers.

2. Wireless Access System for Supporting Ultrahigh Frequency Band

2.1 Distributed Antenna System (DAS)

In a current wireless communication environment, the emergence and proliferation of various devices such as Machine-to-Machine (M2M) devices conducting M2M communication, smart phones requiring large-data transmission, and tablet computers is a driving force behind a very rapid increase in the amount of data required for a network of a wireless communication system. To meet the requirement of a larger amount of data, carrier aggregation and cognitive radio have been developed to efficiently use more frequency bands, and multi-antenna technology and multi-base station cooperation technology have been developed to increase a data capacity in a limited frequency.

The wireless communication environment is evolving toward more densely populated access points (APs) accessible to users. The AP may include a WiFi AP, a cellular femto AP, a cellular pico AP, etc. as well as a cellular macro AP. Likewise, various APs having small coverage are present in one cell, and thus data use of an overall system has been increased. The AP may be configured in the form of remote radio head (RRH) or an antenna node of a distributed antenna system (DAS).

FIG. 10 is a diagram illustrating an example of a DSA that can be configured in embodiments of the present invention.

A DAS system refers to a system in which a single UE manages antennas spread in various positions in a cell, distinguished from a centralized antenna system (CAS) in which antennas of a base station (BS) are concentrated on a cell center. The DAS is distinguished from a femto cell/pico cell in that various antenna nodes constitute one cell.

An early DAS was used to further install and repeat antennas for covering a shadow area. However, the DAS may be considered as a kind of multiple input multiple output (MIMO) system in that BS antennas can simultaneously transmit and receive a plurality of data streams or can support one or more users. In addition, the MIMO system has been considered as a necessary factor for meeting requirements of next-generation communication due to high spectral efficiency.

In terms of the MIMO system, the DAS is advantageous in that relatively uniform quality of communication performance can be ensured irrespective of high power efficiency obtained by reducing a distance between a user and an antenna compared with the CAS, high channel capacity due to a low correlation and interference between BS antennas, and a position of a user in a cell.

Referring to FIG. 10, the DAS includes a BS and an antenna node (group, cluster, etc.) connected thereto. The antenna node may be connected to the BS by wire/wirelessly and may include one or more antennas. In general, antennas belonging to one antenna node have characteristics in which a distance between closest antennas belongs to regionally the same spot within several meters, and an antenna node functions as an AP accessible to a UE. Among conventional DAS technologies, there are many technologies that equate an antenna node with an antenna or do not distinguish the antenna node and the antenna, but a correlation therebetween needs to be clearly defined in order to actually manage the DAS.

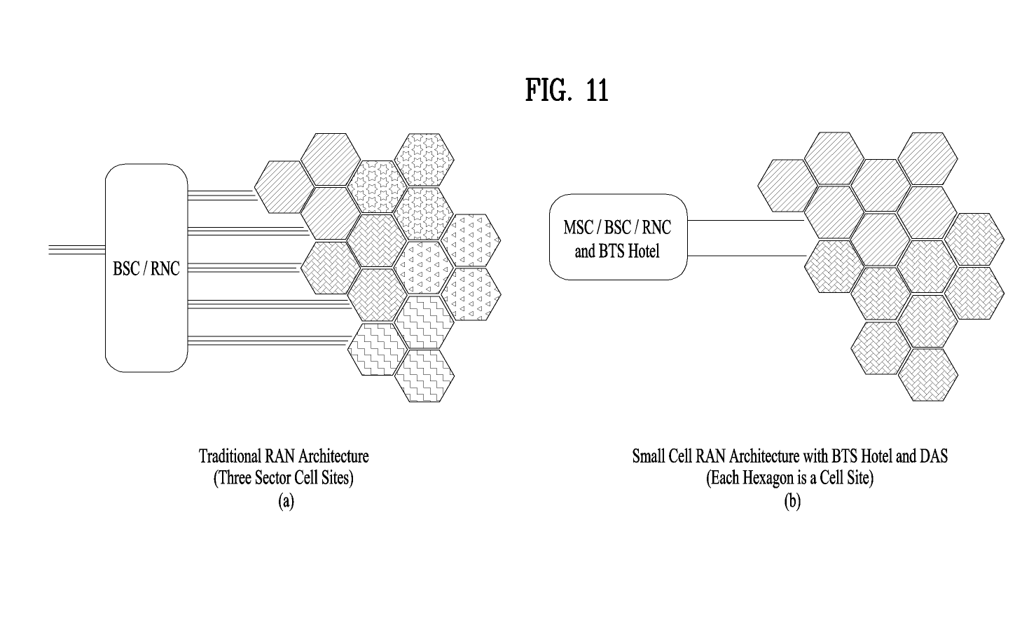

FIG. 11 is a diagram illustrating a concept of a BTS hotel of a DSA that can be used in embodiments of the present invention.

FIG. 11(A) illustrates a conventional RAN configuration. Referring to FIG. 11(A), in a conventional cellular system, one BTS controls three sectors and each BTS is connected to BSC/RNC through a backbone network.

FIG. 11(B) illustrates a small cell RAN configuration including a DSA and a BTS hotel. Referring to FIG. 11(B), in the DAS, BTSs connected to each antenna nodes (ANs) may be collected to one place (BTS hotel). Accordingly, costs for a land and building for installing a BTS may be reduced, the BTS can be easily maintained and managed in one place, and the BTS and the MSC/BSC/RNC can be installed in one place, thereby remarkably increasing backhaul capacity.

Embodiments of the present invention provides a method for configuring a frame for enabling wireless communication when a cell configuration is instantaneously from antenna nodes (ANs) using a concept of a BTS hotel, and a latent gain that can be obtained using the method will be described below.

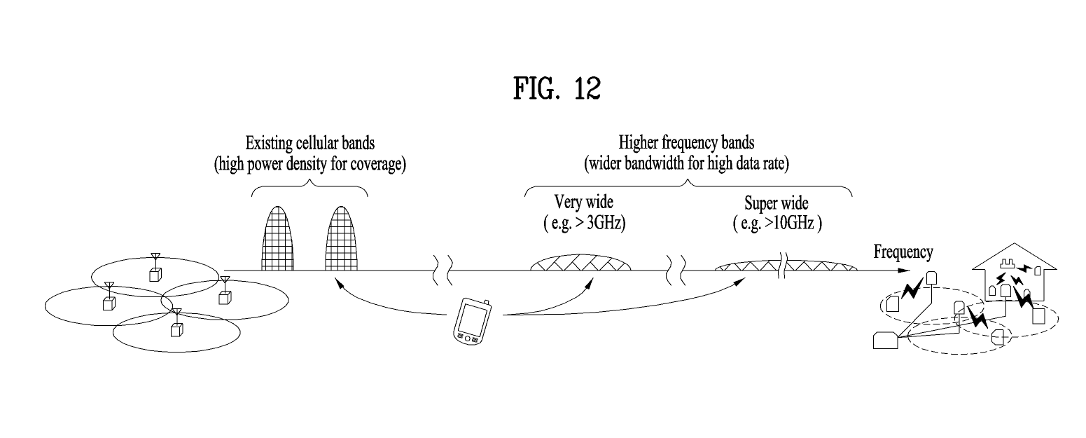

FIG. 12 is a diagram illustrating a frequency band of a small cell that can be used in embodiments of the present invention.

FIG. 12 illustrates a concept of a small cell. That is, it may be expected that a wide system band is configured and operated as a band having a high center frequency instead of a frequency band in which a legacy LTE system is operated, to a UE. In addition, this means that basic cell coverage can be supported based on a control signal such as system information through a legacy cellular band and data transmission for maximizing transmission efficiency is achieved using a wide band through a high frequency of small cell. Accordingly, a concept of local area access (LAA) has, as a target, low-to-medium mobility UEs positioned in a relatively narrow area, which are small cells in a unit of 100 m, a distance between a UE and a BS of which is smaller than a legacy cell in km unit.

Accordingly, these cells may have the following channel characteristics as a distance between a UE and a BS is reduced and a high frequency band is used.

(1) Delay spread: Delay of a signal may be reduced as a distance between a BS and a UE is increased.

(2) Subcarrier spacing: When the same OFDM based frame as an LTE is applied, an allocated frequency band is large, and thus subcarrier spacing may be set as an extremely high value compared with a legacy frequency of 15 kHz.

(3) Doppler's frequency: Since a high frequency band is used, UEs with the same velocity have higher Doppler's frequency than a low frequency band, and thus coherent time is extremely reduced.

2.2 Channel Characteristic of Ultrahigh Frequency Band and Doppler Spectrum

An LTE/LTE-A system designs RS density and pattern based on coherent time derived based on a maximum Doppler's frequency. A UE may estimate a radio channel through an RS and decode received data. In reality, assuming a center frequency of 2 GHz and UE moving speed of 500 km/h, the LTE system may have a maximum Doppler's frequency (fₐ) is 950 Hz, about 1000 Hz.

In general, about 50% of coherent time may be achieved from a maximum Doppler's frequency. Accordingly, in the LTE system, the following equation 18 is satisfied.

$${T}_{c} = \frac{1}{2 {f}_{d}} ≅ 0.5 ms \qquad [ Equation 18 ]$$

Equation 18 above means that maximum two RSs are required in coherent time. That is, in the LTE system, the RS pattern may be embodied such that channel estimation is possible in any mobile situations up to 500 km/h as maximum moving speed of a UE or less.

However, in an ultrahigh frequency band having a center frequency of several tens of GHz instead of 3 GHz or less in which legacy cellular mobile communication is served, a UE with relatively low speed may experience a high Doppler's frequency. For example, assuming that center frequencies of the UEs are 2 GHz and 20 GHz, respectively, and the UEs have the same speed of 30 km/h, a maximum Doppler's frequency may be calculated as follows.

$$\begin{matrix}Fc = 2 GHz , UE speed ( v ) = 30 km \text{/} h \to {f}_{d} = \frac{v}{c} \times {f}_{c} = 55.6 Hz & 1 ) \\ Fc = 20 GHz , UE speed ( v ) = 30 km \text{/} h \to {f}_{d} = \frac{v}{c} \times {f}_{c} = 556 Hz & 2 )\end{matrix}$$

In this case, the UEs have the same c=3×10⁸, fc is a center frequency, and v is moving speed of a UE. That is, even if mobile UEs have the same speed, when a frequency of a frequency band in which a UE performs communication is increased, the UE may experience a higher Doppler's frequency.

In addition, according to the characteristics of an ultrahigh frequency band, unlike a conventional radio channel of several GHz or less, a direct compensation scheme can be applied to changed characteristics of a Doppler spectrum. In general, since a wavelength λ of an antenna element is reduced in a high frequency band, it may be possible to configure a massive antenna that can include greater antennas in the same space. As such, narrow beamforming can be easily applied.

In addition, due to a high center frequency of several tens of GHz, higher path loss than a basic communication band of several GHz occurs, and due to the characteristics of a high frequency band, additional path loss such as additional environment loss, etc. occurs. Accordingly, additional path attenuation of components that are reflected and emitted via scattering from a conventional multipath channel is relatively high, and thus a line of sight (LOS) dominant environment can be formed. That is, according to the characteristics of a high frequency band, an environment in which a BS can easily apply a narrow beamforming scheme may be formed.

According to the narrow beamforming, a signal is received only in a specific direction of a receiver of a UE, but not in all directions, and thus a Doppler spectrum has a phenomenon whereby a spectrum becomes sharper, as illustrated in FIG. 13.

FIG. 13 is a diagram illustrating distribution of Doppler spectrum during narrow beamforming that can be used in an embodiment of the present invention.

FIG. 13(a) illustrates a Doppler spectrum in a general band. A horizontal axis is a frequency axis and a vertical axis is a power spectrum density (PSD) axis. A signal is received in all directions of a receiver of a UE in a general frequency band (e.g., an LTE system band), and thus a Doppler spectrum of the signal received by the UE exhibits a shape ‘U’ as illustrated in FIG. 13(a).

FIG. 13(b) illustrates a Doppler spectrum in an ultrahigh frequency band. A signal is received in a specific direction of a receiver of a UE in an ultrahigh frequency band, and thus a Doppler spectrum of the signal received by the UE is changed as illustrated in FIG. 13(b).

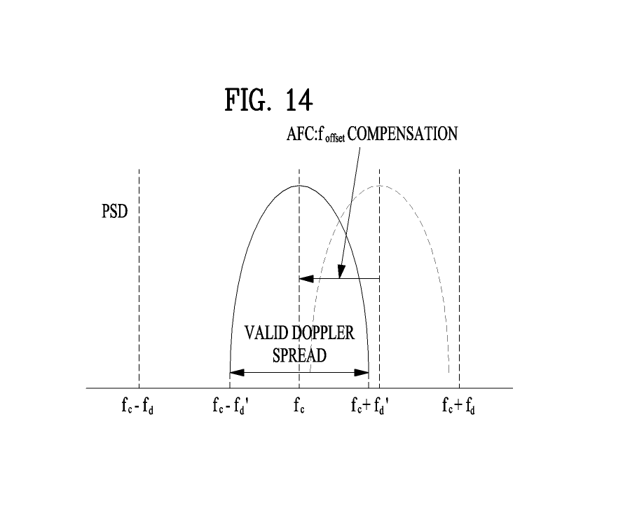

FIG. 14 is a diagram illustrating a case in which a Doppler spectrum is reduced during narrow beamforming according to an embodiment of the present invention.

The Doppler spectrum illustrated in FIG. 13(b) can be directly compensated using the characteristics of a Doppler spectrum that considers narrow beamforming, like in FIG. 14. That is, a spectrum condenses into a partial region, but not entire Doppler spread, and thus last Doppler spectrum attenuation may be possible using an auto frequency control/adaptive frequency control (AFC) function at a receiving end, as illustrated in FIG. 14.

That is, when a maximum Doppler frequency is reduced to fd′(<fd) but not fd through the AFC function, coherent time may be increased according to Equation 18 which is an inverse function of a maximum Doppler frequency. This means that a channel is not changed for a longer time period in a time axis. An ultrahigh frequency band is a communication environment friendly with narrow beamforming using a plurality of antennas due to propagation characteristics. Accordingly, static channel duration may be increased in a time axis using the AFC function at a receiving end, thereby achieving more stable time-varying channel characteristics.

3. Method for Transmitting System Information

A channel for transmitting system information to a UE from a BS may be largely classified to a unicast channel for transmitting system information only to a specific UE and a broadcast channel for commonly transmitting system information to all UEs. For example, a channel for transmitting system information only to a specific UE, such as a general data channel, may be classified as a unicast channel, and a channel for commonly transmitting system information to all UEs in a cell, such as a physical broadcasting channel (PBCH) may be classified as a broadcast channel.

According to the following embodiments of the present invention, methods for configuring a broadcast channel and a unicast channel in an ultrahigh frequency band will be described.

3.1 Broadcast Channel and Unicast Channel of Ultrahigh Frequency Band

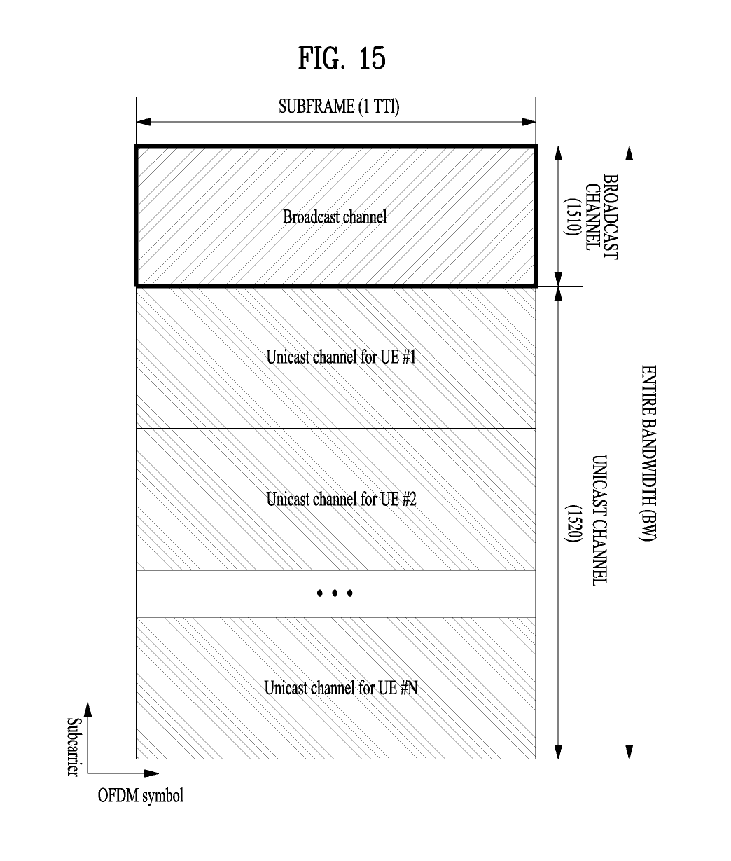

FIG. 15 is a diagram illustrating an example of a system information transmission channel configuration according to an embodiment of the present invention.

In order to fully use the characteristics of an ultrahigh frequency band, when a broadcast channel and a unicast channel are designed via a frequency division multiplexing (FDM) method in a whole transmission time interval (TTI), but not a partial time-frequency region and time region in a subframe or a TTI, a UL form of resource configuration like in FIG. 15 may be achieved.

That is, some FDM regions may be allocated as a broadcast channel region 1510 for commonly transmitting system information to all UEs and the remaining resource regions may be allocated as a unicast channel region 1520 for transmitting specific system information items to respective UEs. In this case, data transmission for each UE may be basically performed in a unicast channel region of a UE.

A channel region is divided using an FDM method like in FIG. 15 because a time axis is less affected by Doppler spread than frequency axis in an ultrahigh frequency band, as described above. Accordingly, a stable channel can be designed using an FDM method compared with a TDM method.

Basically, narrow beamforming appropriate for data transmission for each UE is performed in a unicast channel region, and a Doppler spectrum is formed as illustrated in FIGS. 13(b) and 14. Accordingly, Doppler reduction is performed via AFC for each unicast channel region of each UE. Accordingly, the unicast channel region is a region in which a reference signal with reduced RS density, to which the Doppler spread is reduced, can be managed.

However, distinguished from a data transmission region allocated to each UE, narrow beamforming corresponding to only a specific UE cannot be performed in a broadcast channel region for transmitting a broadcast channel signal. Accordingly, narrow beamforming for each UE cannot be performed, and thus Doppler reduction gain cannot be obtained. This means that, since coherent time is reduced in time axis, time axis RS density for channel estimation needs to be increased. In the case of the broadcast channel region, a lowest modulation index needs to be used in order to always support a lowest UE by link performance, and thus a transfer rate is low compared with a used allocated resource.

3.2 Reference Signal Configuration Used in Ultrahigh Frequency Band

A UE does not necessarily detect a frequency band that is divided into FDM regions in order to information to be periodically updated, except that the UE needs to perform initial access on a network. That is, narrow beamforming is appropriately embodied so as to receive system information through a unicast channel using a band with excellent link performance. In this case, the UE may receive system information from a region that applies AFC to increase coherent time and has improved link quality. Accordingly, the eNB does not necessarily transmit system information with a low modulation order such as QPSK or a low transfer rate such as a 1/3 code rate.

As a result, time axis RS density of a region for transmitting system information through a unicast channel may be allocated to be lower than time axis RS density of a region for transmitting a broadcast channel signal.

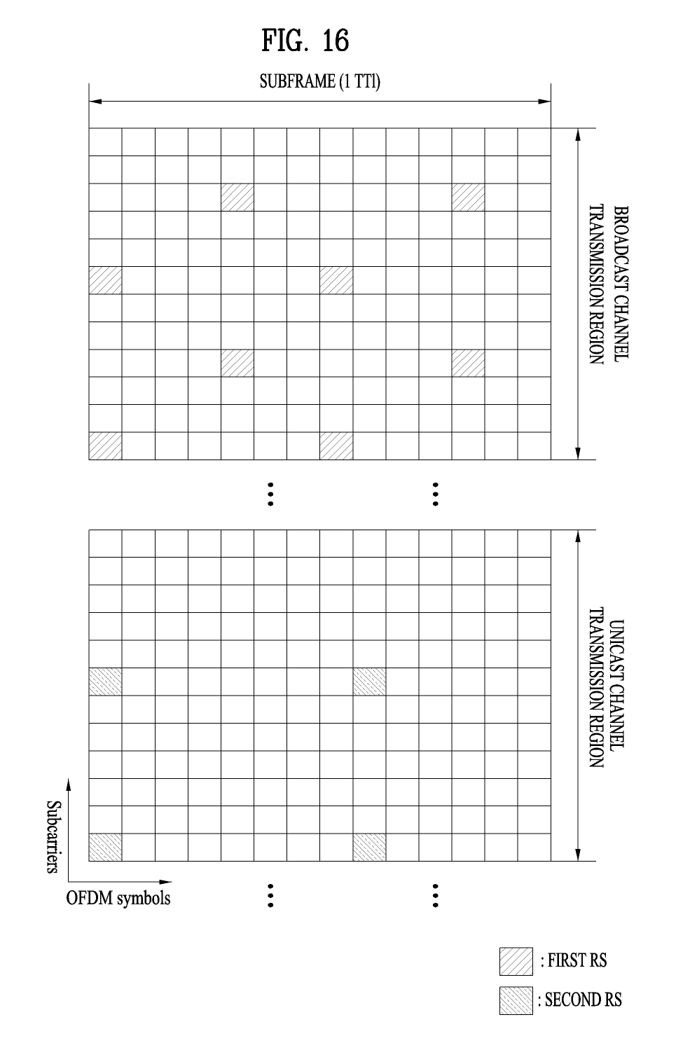

FIG. 16 is a diagram illustrating an example of a reference signal configured used in an ultrahigh frequency band according to an embodiment of the present invention.

In FIG. 16, basically, the broadcast channel region 1510 and the unicast channel region 1520 described with reference to FIG. 15 are assumed to be configured. That is, the broadcast channel region and the unicast channel region configured in FIG. 16 are configured in the same subframe.

Referring to FIG. 16, the number of total RSs allocated to the broadcast channel region is 8, and the number of total RSs allocated to the unicast channel region is 4. In addition, it is checked that time axis RS density of the broadcast channel region is higher than time axis RS density of the unicast channel region. However, the RS configuration configured in FIG. 16 is purely exemplary, and any ratio may be possible as long as RS density allocated to the unicast channel region is lower than RS density allocated to the broadcast channel region.

Since the broadcast channel region is a region for transmitting system information to be transmitted to all UEs, even if data throughput is reduced, RS density needs to be increased. However, since the unicast channel region is a region for transmitting system information to be transmitted to a specific UE, and channel variation is relatively low in a time axis of an ultrahigh frequency band, RS density may be configured to be low.

Accordingly, the UE may allocate a broadcast channel region and a unicast channel region in a specific frame. In this case, RS density may be allocated to be relatively high in the broadcast channel region in order to transmit common system information to all UEs in a corresponding cell, compared with the unicast channel region. In addition, RS density may be allocated to be relatively low in the unicast channel region in order to transmit specific system information to be transmitted to specific UEs in a corresponding cell, compared with the broadcast channel region.

In this case, the allocated RS in FIG. 16 may be the RS described with reference to FIGS. 7 to 9 or may be an RS for DL transmission, used in a 3GPP LTE/LTE-A system. In addition, in FIG. 16, the RS allocated to the broadcast channel region may be a CRS and/or a UE-RS or the RS allocated to the unicast channel region may be a UE-RS and/or a CSI-RS. Needless to say, the RS allocated to the unicast channel region may be a CRS. Alternatively, the RS allocated to the broadcast channel region and the RS allocated to the unicast channel region may have the same type or different types of RSs may be used according to use of system information transmission.

In an RS configuration like in FIG. 16, when system information is transmitted to a UE through unicast fallback and narrow beamforming is performed in the UE, time axis RS density may be further reduced.

However, when the UE performs initial access or narrow beamforming is not performed, the UE may acquire system information through a broadcast channel without a unicast fallback mode.

3.3 Method for Transmitting System Information in Ultrahigh Frequency Band

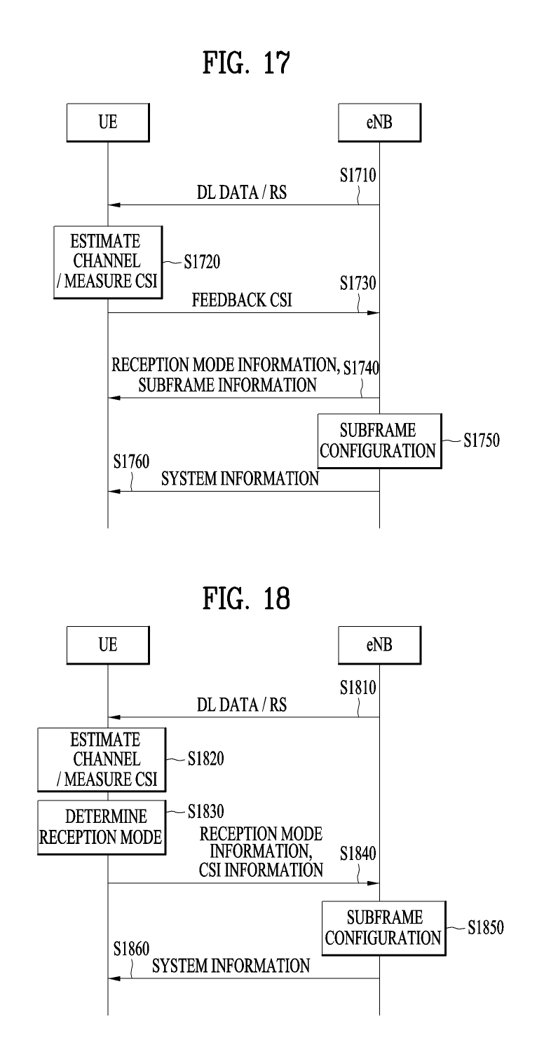

FIG. 17 is a diagram illustrating an example of a method for transmitting system information in an ultrahigh frequency band according to an embodiment of the present invention.

Hereinafter, an eNB may determine whether system information is transmitted in a unicast fallback mode using feedback information. Referring to FIG. 17, the eNB transmits DL data and/or a reference signal (RS) to a UE (S1710).

The UE estimates a channel using the DL data and/or RS transmitted from the eNB and measures channel state information (CSI). In this case, the CSI may include CQI, PMI, RI, and/or Doppler frequency information (S1720).

Then the UE feedbacks the CSI to the eNB using a PUSCH signal and/or a PUCCH signal (S1730).

The eNB determines whether the system information is transmitted in a broadcasting channel or a unicast channel based on the information that is fed back from UEs. The eNB transmits information about a subframe in which the determined reception mode and system information are to be transmitted, to the UE (S1740).

The eNB configures a subframe for transmission of the system information. For example, the eNB configures a subframe in which the system information is to be transmitted based on the feedback information of operation S1720 according to the subframe configuration and RS allocation structure that are described with reference to FIGS. 15 and 16 (S1750).

The eNB transmits the system information to the UE through a broadcasting channel region and/or a unicast channel region according to reception mode information indicated by the subframe information transmitted in operation S1740 (S1760).

FIG. 18 is a diagram illustrating another example of a method for transmitting system information in an ultrahigh frequency band according to an embodiment of the present invention.

FIG. 18 illustrates a method for determining whether a current mode is a unicast fallback mode based on channel information estimated by a UE. Referring to FIG. 18, an eNB transmits DL data and/or a reference signal (RS) to a UE (S1810).

The UE estimates a channel using the UL data and/or RS transmitted from the eNB and measures channel state information (CSI). In this case, the CSI may include CQI, PMI, RI, and/or Doppler frequency information (S1820).

The UE determines reception mode information about whether system information is received in a broadcast channel or a unicast channel based on estimated CSI and/or Doppler frequency information (S1830).

Then the UE feedbacks the reception mode information and CSI information to the eNB using a PUSCH and/or PUCCH signal (S1840).

The eNB configures a subframe for transmitting system information. For example, the eNB configures a subframe for transmitting the system information based on the feedback information of operation S1840 according to the subframe configuration and RS allocation configuration described with reference to FIGS. 15 and 16 (S1850).

The eNB transmits the system information to the UE through the broadcast channel region and/or the unicast channel region according to the reception mode information received in operation S1840 (S1860).

In FIG. 18, the eNB may notify the UE of subframe information for transmitting system information. Alternatively, system information may be transmitted from a subframe fixed in a system.

According to another embodiment of the present invention, the eNB directly estimates and/or predicts a channel situation with the UE and determines a reception mode (i.e., a unicast fallback mode) of the UE using the corresponding information. In addition, the eNB transmits reception mode information about the system information to the UE.

For example, the eNB may estimate a channel situation between UEs without feedback using an uplink sounding reference signal (UL SRS) or UL/DL channel reciprocity of TDD. The eNB may determine a reception mode for transmitting system information using the estimated channel information. For example, the eNB determines whether system information is transmitted through a broadcast channel or a unicast channel and transmits the corresponding reception mode information to the UE.

In the aforementioned embodiments of the present invention, system information may include cell identifier, center frequency information, a system bandwidth, HARQ configuration, subframe/system frame information, antenna configuration information, and/or RACH configuration information.

4. Apparatus

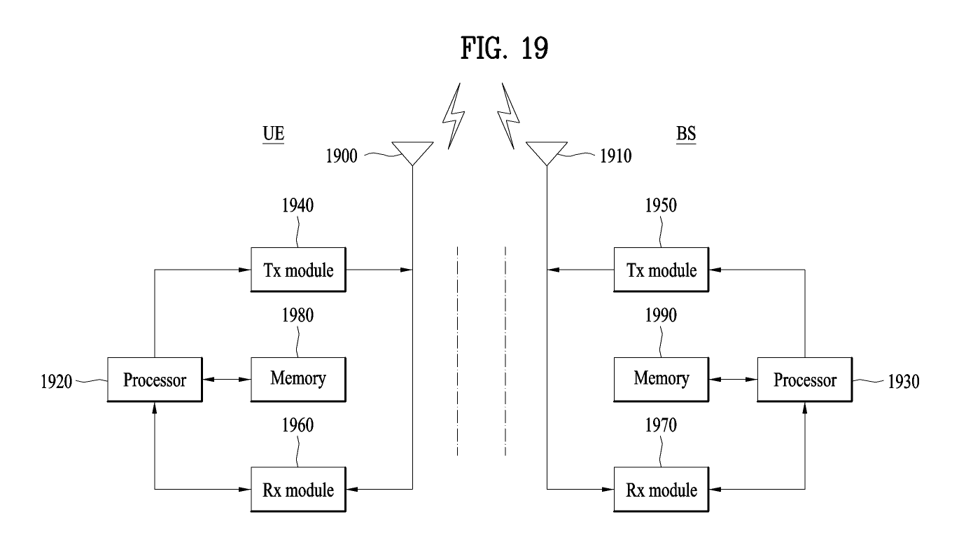

Apparatuses illustrated in FIG. 19 are means that can implement the methods described before with reference to FIGS. 1 to 18.

A UE may act as a transmitter on a UL and as a receiver on a DL. An eNB may act as a receiver on a UL and as a transmitter on a DL.

That is, each of the UE and the eNB may include a Transmission (Tx) module 1940 or 1950 and a Reception (Rx) module 1960 or 1970, for controlling transmission and reception of information, data, and/or messages, and an antenna 1900 or 1910 for transmitting and receiving information, data, and/or messages.

Each of the UE and the eNB may further include a processor 1920 or 1930 for implementing the afore-described embodiments of the present disclosure and a memory 1980 or 1990 for temporarily or permanently storing operations of the processor 1920 or 1930.

The embodiments of the present invention can be implemented using the components and functions of the aforementioned UE and eNB apparatus. For example, a process of the eNB may combine the methods disclosed in the aforementioned paragraphs 1 to 3 and allocate a broadcasting channel region and unicast channel region for transmission of system information. In addition, an RS for transmission of system information may be allocated and transmitted in the corresponding channel region.

The Tx and Rx modules of the UE and the eNB may perform a packet modulation/demodulation function for data transmission, a high-speed packet channel coding function, OFDMA packet scheduling, TDD packet scheduling, and/or channelization. Each of the UE and the eNB of FIG. 18 may further include a low-power Radio Frequency (RF)/Intermediate Frequency (IF) module.

Meanwhile, the UE may be any of a Personal Digital Assistant (PDA), a cellular phone, a Personal Communication Service (PCS) phone, a Global System for Mobile (GSM) phone, a Wideband Code Division Multiple Access (WCDMA) phone, a Mobile Broadband System (MBS) phone, a hand-held PC, a laptop PC, a smart phone, a Multi Mode-Multi Band (MM-MB) terminal, etc.

The smart phone is a terminal taking the advantages of both a mobile phone and a PDA. It incorporates the functions of a PDA, that is, scheduling and data communications such as fax transmission and reception and Internet connection into a mobile phone. The MB-MM terminal refers to a terminal which has a multi-modem chip built therein and which can operate in any of a mobile Internet system and other mobile communication systems (e.g. CDMA 2000, WCDMA, etc.).

Embodiments of the present disclosure may be achieved by various means, for example, hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the embodiments of the present disclosure may be implemented in the form of a module, a procedure, a function, etc. performing the above-described functions or operations. A software code may be stored in the memory 1980 or 1990 and executed by the processor 1920 or 1930. The memory is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL APPLICABILITY

The present disclosure is applicable to various wireless access systems including a 3GPP system, a 3GPP2 system, and/or an IEEE 802.xx system. Besides these wireless access systems, the embodiments of the present disclosure are applicable to all technical fields in which the wireless access systems find their applications.

1. A method for transmitting system information in a wireless access system for supporting an ultrahigh frequency band, the method comprising:
allocating one or more of a broadcast channel region and a unicast channel region, for transmission the system information, to a specific subframe by a base station (BS); and
transmitting the system information using one or more of the broadcast channel region and the unicast channel region by the BS,
wherein the number of first reference signals allocated to the broadcast channel region is greater than the number of second reference signals allocated to the unicast channel region.

2. The method according to claim 1, wherein the system information is transmitted to a specific user equipment (UE) using a narrow beamforming method when the system information is transmitted through the unicast channel region.

3. The method according to claim 1, wherein the system information is transmitted to all user equipments (UEs) contained in a cell of the BS when the system information is transmitted through the broadcast channel region.

4. The method according to claim 1, further comprising:
receiving feedback information comprising channel state information (CSI) from one or more user equipments (UEs);
determining a reception mode indicating a channel region for transmitting the system information based on the feedback information; and
transmitting information about the reception mode and information about the specific subframe.

5. The method according to claim 1, further comprising:
receiving information about a reception mode indicating a channel region for transmitting the system information, determined based on channel state information (CSI), from one or more user equipments (UEs); and
transmitting the system information in the specific subframe using information about the reception mode.

6. A method for receiving system information in a wireless access system for supporting an ultrahigh frequency band, the method comprising:
receiving the system information using one or more of a broadcast channel region and a unicast channel region in a specific subframe, by a user equipment (UE),
wherein the number of first reference signals allocated to the broadcast channel region is greater than the number of second reference signals allocated to the unicast channel region.

7. The method according to claim 6, wherein the system information is transmitted to the UE using a narrow beamforming method when the system information is transmitted through the unicast channel region.

8. The method according to claim 6, wherein the system information is transmitted to all UEs contained in a cell of a base station (BS) when the system information is transmitted through the broadcast channel region.

9. The method according to claim 6, further comprising:
measuring channel state information (CSI) by the UE;
transmitting feedback information comprising the CSI by the UE; and
receiving information about the specific subframe and information about a reception mode indicating a channel region for transmitting the system information, determined based on the feedback information.

10. The method according to claim 6, further comprising:
measuring channel state information (CSI) by the UE;
determining a reception mode indicating a channel region for transmitting the system information based on the CSI by the UE;
transmitting the CSI and information about the reception mode by the UE; and
receiving the system information in the specific subframe using the information about the reception mode.

11. A base station (BS) for transmitting system information in a wireless access system for supporting an ultrahigh frequency band, the BS comprising:
a transmitter;
a receiver; and
a processor for supporting transmission of the system information, wherein:
the processor is configured to allocate one or more of a broadcast channel region and a unicast channel region, for transmission the system information, to a specific subframe, and to transmit the system information using one or more of the broadcast channel region and the unicast channel region through the transmitter; and
the number of first reference signals allocated to the broadcast channel region is greater than the number of second reference signals allocated to the unicast channel region.

12. The BS according to claim 11, wherein the system information is transmitted to a specific user equipment (UE) using a narrow beamforming method when the system information is transmitted through the unicast channel region.

13. The BS according to claim 11, wherein the system information is transmitted to all user equipments (UEs) contained in a cell of the BS when the system information is transmitted through the broadcast channel region.

14. The BS according to claim 11, wherein the processor is configured to control the receiver to receive feedback information comprising channel state information (CSI) from one or more user equipments (UEs), to determine a reception mode indicating a channel region for transmitting the system information based on the feedback information, and to control the transmitter to transmit information about the reception mode and information about the specific subframe.

15. The BS according to claim 11, wherein the processor is configured to control the receiver to receive information about a reception mode indicating a channel region for transmitting the system information, determined based on channel state information (CSI) from one or more user equipments (UEs), and to control the transmitter to transmit the system information in the specific subframe using information about the reception mode.
